(19) United States
(12) Patent Application Publication
(10) Pub. No.: US 2009/0286936 A1
(43) Pub. Date: Nov. 19, 2009

(54) COMPOSITION FOR FORMATION OF MOLD

(75) Inventors: Toshiyuki Ogata, Kanagawa-ken (JP); Hideo Hada, Kanagawa-ken (JP); Shigenori Fujikawa, Saitama-ken (JP); Toyoki Kunitake, Kukuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignees: Tokyo Ohka Kogyo Co., Ltd., Kanagawa-ken (JP); Riken, Saitama-ken (JP)

(21) Appl. No.: 11/912,388

(22) PCT Filed: Apr. 20, 2006
(86) PCT No.: PCT/JP2006/308307

§ 371 Date: Oct. 23, 2007

(30) Foreign Application Priority Data
Apr. 25, 2005 (JP) 2005-126421

(51) Int. Cl. C08F 12/04

(52) U.S. Cl. 525/328.8; 526/313

(57) ABSTRACT

Disclosed is a composition for formation of a mold, which is used in a method for producing a nanostructure by removing a portion of a thin film formed on the surface of a mold, and removing the mold, the composition including an organic compound, which has a hydrophilic group and has a molecular weight of 500 or more.

### TECHNICAL FIELD

The present invention relates to a composition for formation of a mold, which is suited to production of a nanostructure using a mold.

Priority is claimed on Japanese Patent Application No. 2005-126421, filed Apr. 25, 2005, the contents of which are incorporated herein by reference.

### BACKGROUND ART

A technology of forming a minute pattern is widely employed to produce an integrated circuit (IC) in the semiconductor industry, and focus the spotlight of attention. Particularly, a two-dimensional minute pattern has been studied and developed quite intensively, because it is directly connected with the production of the integrated circuits and high integration. Miniaturization of the two-dimensional pattern is generally conducted by technologies such as direct writing utilizing various beams, lights, electrons, and ions, and projection/transfer (optical lithography, nanoimprint or the like) of a specific mask pattern.

For example, a lithography method has been developed most intensively from an industrial point of view, and the basic concept in promotion of miniaturization is that “a wavelength of light or electron beam to be irradiated is shortened, thereby conducting microfabrication”. Therefore, the basic strategy includes shortening of the wavelength of light to be irradiated and development of materials and equipment corresponding thereto. However, since short wavelength light is used in this technology, an exposure apparatus becomes very expensive and enormous investment is required for facilities of the process. Also, materials and processes must be designed so as to exert a maximum wavelength effect. Furthermore, it is necessary to introduce a special functional group, which does not absorb short wavelength light to be irradiated and improves exposure accuracy, into a resist material required for a lithography method. Material design requires various conditions such as high resistance of a post-treatment.

In the case of electron beam processes and ion beam processes other than an optical lithography method, individual direct writing with beams is conducted, and thus there is a limitation on improvement of throughput. Although a dip-pen lithography method is proposed as a technology using an atomic force microscope similar to the above method, it is hard to industrially apply the method, because a pattern is formed only one by one if the method is used.

A technology capable of transferring a pattern using a simple method includes nanoimprint. However, there are a lot of restrictions on the material to which imprint can be applied. In addition, since microfabrication accuracy of a mold depends on a conventional lithography method, essential improvement in microfabrication accuracy is not achieved.

As described above, there are large restrictions and problems on miniaturization in conventionally known technologies of forming a minute pattern, and thus it is required to develop a new microfabrication technology so as to solve these problems.

In contrast, the present inventors disclose a material for forming a thin film of an amorphous metal oxide (see patent reference 1), a method of producing an organic/a metal oxide composite thin film (see patent document 2), and a nanomaterial of a composite metal oxide (see patent document 3), and also disclose a nano-level thin film and a producing method-thereof.

[Patent Reference 1]

Japanese Unexamined Patent Application, First Publication No. 2002-338211

[Patent Reference 2]

Japanese Unexamined Patent Application, First Publication No. Hei 10-249985

[Patent Reference 3]

International Publication WO 03/095193

### DISCLOSURE OF THE INVENTION

### Problems to be Solved by the Invention

The present invention has been made to solve the above problems and an object thereof is to provide a composition for formation of a mold, which can realize the production of a nanostructure capable of controlling the size at the nano-level.

### Means for Solving the Problems

To achieve the above object, the present invention employed the following constitutions.

Namely, a first aspect of the present invention is a composition for formation of a mold, which is used in a method of producing a nanostructure by removing a portion of a thin film formed on the surface of a mold, and then removing the mold, the composition containing an organic compound, which has a hydrophilic group and has a molecular weight of 500 or more.

A second aspect of the present invention is a composition for formation of a mold, which is used in a method of producing a nanostructure by removing a portion of a thin film formed on the surface of a mold, thereby exposing a portion of the mold, and then removing the mold, the composition containing an organic compound, which has a hydrophilic group and has a molecular weight of 500 or more.

A third aspect of the present invention is a composition for formation of a mold, which is used in a method of producing a nanostructure by removing the top face of a thin film formed on the surface of a rectangular mold and then removing the mold, thereby leaving only a thin film formed on the side face of the mold, the composition containing an organic compound, which has a hydrophilic group and has a molecular weight of 500′ or more.

### EFFECTS OF THE INVENTION

According to the present invention, a composition for formation of a mold, which can realize the production of a nanostructure capable of controlling the size at the nano-level is provided.

### BRIEF DESCRIPTION OF THE DRAWINGS

FIG. 1 shows a schematic view of a first embodiment of the present invention.

FIG. 2 shows a schematic view of a second embodiment of the present invention.

FIG. 3 shows a schematic view of a third embodiment of the present invention.

FIG. 4 shows a schematic view of a fourth embodiment of the present invention.

FIG. 5 shows a schematic view of a fifth embodiment of the present invention.

FIG. 6 shows a schematic view of a sixth embodiment of the present invention.

FIG. 7 shows a schematic view of a seventh embodiment of the present invention.

FIG. 8 shows a schematic view of an eighth embodiment of the present invention.

FIG. 9 is a scanning electron micrograph of a nanostructure obtained in Example 1.

FIG. 10 is a scanning electron micrograph of a nanostructure obtained in Example 2.

### BEST MODE FOR CARRYING OUT THE INVENTION

The present invention will now be described in detail.

### [Composition for Formation of Mold]

The composition for formation of a mold of the present invention contains an organic compound which has a hydrophilic group and has a molecular weight of 500 or more. With the composition, a thin film can be satisfactorily formed on a mold formed of the composition, and thus a three-dimensional nanostructure having a good shape can be obtained.

The organic compound contained in the composition for formation of a mold of the present invention is roughly classified into a low molecular compound having a molecular weight of 500 or more and 2,000 or less, and into a high molecular polymer compound having a molecular weight of more than 2,000. In the case of the polymer compound, a polystyrene equivalent weight average molecular weight determined using GPC (gel permeation chromatography) is used as the “molecular weight”.

It is not preferred that the molecular weight of the organic compound is less than 500 because it becomes difficult to form a nano-level mold.

As the hydrophilic group of the organic compound contained in the composition for formation of a mold, at least one kind selected from the group consisting of a hydroxyl group, a carboxy group, a carbonyl group, an ester group, an amino group, and an amide group is preferably used. Of these groups, a hydroxyl group , especially an alcoholic hydroxyl group and a phenolic hydroxyl group, a carboxy group, and an ester group are more preferred.

Of these groups, a carboxy group, an alcoholic hydroxyl group, and a phenolic hydroxyl group are particularly preferred because a thin film is easily formed on the surface of a mold. These are also preferred because a nanostructure with less line edge roughness can be formed at the nano-level.

When a hydrophilic group is present on the surface of a mold, the hydrophilic group can be used as a functional group (reactive group) which interacts with the material of a thin film formed on the mold. Thus, a thin film having high adhesion with the mold can be formed. Also, a thin film having high density can be formed on the mold so as to obtain a nanostructure having a shape which exhibits sufficient dynamic strength.

The proportion of the hydrophilic group in the organic compound contained in the composition for formation of a mold exerts an influence on the amount per unit area of the hydrophilic group which is present on the surface of a mold. Therefore, it can exert an influence on adhesion and density of the thin film formed on the mold.

When the organic compound is the polymer compound described above, the proportion of the hydrophilic group is preferably within a range from 0.2 equivalents or more, more preferably from 0.5 to 0.9 equivalents, and still more preferably from 0.6 to 0.75 equivalents.

This means that when the polymer compound comprises a structural unit having a hydrophilic group and other structural units, the proportion of the former structural unit is preferably 20 mol % or more, more preferably from 50 to 80 mol %, and still more preferably from 60 to 75 mol %.

The composition for formation of a mold of the present invention may be a composition which contains an organic compound which has a hydrophilic group and has a molecular weight of 500 or more, and can form a pattern having a desired shape. Examples of the method of a pattern formation having a desired shape include an imprint method and a lithography method. Of these methods, a lithography method is preferred.

The composition for formation of a mold preferably has radiation sensitivity so as to form a minute pattern with high accuracy, because a lithography method can be used in the case of forming a mold using the composition for formation of a mold.

It is preferred that the organic compound is a compound having, in addition to the hydrophilic group, an acid dissociable, dissolution inhibiting group, and that the composition for formation of a mold further contains an acid generator. In the present invention, the hydrophilic group may also serve as the acid dissociable, dissolution inhibiting group.

When the organic compound is the polymer compound described above, it is a resin comprising a unit having a hydrophilic group and a unit having an acid dissociable, dissolution inhibiting group in which the weight average molecular weight is within a range from more than 2,000 to 30,000, and the proportion of the unit having a hydrophilic group is 20 mol % or more, and preferably 50 mol % or more.

The weight average molecular weight is more preferably within a range from 3,000 to 30,000, and still more preferably from 5,000 to 20,000.

The proportion of the unit having a hydrophilic group is preferably 60 mol % or more, and still more preferably 75 mol % or more. The upper limit is not specifically limited, but is preferably 80 mol % or less.

It is preferred that the unit having a hydrophilic group is a unit having a carboxy group, an alcoholic hydroxyl group, or a phenolic hydroxyl group, and more preferably a unit derived from acrylic acid, methacrylic acid, a (meth)acrylate ester having an alcoholic hydroxyl group, or hydroxystyrene.

When the organic compound is the low molecular compound described above, it preferably has a hydrophilic group in a proportion within a range from 1 to 20 equivalents, and more preferably from 2 to 10 equivalents, per one molecule of the low molecular compound.

As used herein, the expression “having a hydrophilic group in a proportion within a range from 1 to 20 equivalents per one molecule” means that 1 to 20 hydrophilic groups are present in one molecule.

Preferred embodiments of the composition for formation of a mold will now be described.

(1) Examples of the radiation-sensitive composition for formation of a mold which contains a polymer compound as an organic compound include a composition for formation of a mold which contains (A-1) a polymer compound having a hydrophilic group and an acid dissociable, dissolution inhibiting group and (B) an acid generator.
(2) Examples of the radiation-sensitive composition for formation of a mold which contains a low molecular compound as an organic compound include a composition for formation of a mold which contains (A-2) a low molecular compound having a hydrophilic group and an acid dissociable, dissolution inhibiting group and (B) an acid generator.

The composition for formation of a mold (1) or (2) may contain both the component (A-1) and the component (A-2).

As the component (A-1) and component (A-2), as long as the component is an organic compound which has a hydrophilic group and has a molecular weight of 500 or more, organic compounds used for a chemically-amplified photoresist can be used either alone, or in combinations of two or more different organic compounds.

These will now be explained in detail.

### <Component (A-1)>

As the component (A-1), an alkali-soluble resin or a resin which can be converted to an alkali-soluble state can be used. The former case describes a so-called negative resist composition, and the latter case describes a positive resist composition. In the present invention, a positive resist composition is preferably used.

In the case of a negative composition, a crosslinking agent is added to the composition for formation of a mold together with the component (B). Then, during mold pattern formation, when acid is generated from the component (B) upon exposure, the action of this acid causes crosslinking to occur between the component (A-1) and the crosslinking agent, causing the composition to become alkali-insoluble. As the crosslinking agent, an amino-based crosslinking agent such as a melamine, urea, or glycoluril containing a methylol group or alkoxymethyl group is typically used.

In the case of the positive composition, the component (A-1) is an alkali-insoluble compound containing so-called acid dissociable, dissolution inhibiting groups, and when acid is generated from the component (B) upon exposure, this acid causes the acid dissociable, dissolution inhibiting groups to dissociate, and thereby the component (A-1) becomes alkali-soluble.

As the component (A-1), a copolymer resin including a structural unit derived from a novolak resin, a hydroxystyrene-based resin, a (meth)acrylate ester resin, or hydroxystyrene, and a structural unit derived from a (meth)acrylate ester is preferably used.

In the present description, the expression “(meth) acrylic acid” means either one of, or both, methacrylic acid and acrylic acid. Also, the expression “(meth)acrylate” means either one of, or both of methacrylate and acrylate. The structural unit derived from the (meth)acrylate ester is a structural unit formed by the cleavage of the ethylenic double bond of the (meth)acrylate ester, and is sometimes referred to as a (meth)acrylate structural unit. The structural unit derived from hydroxystyrene is a structural unit formed by the cleavage of the ethylenic double bond of the hydroxystyrene or α-methylhydroxystyrene, and is sometimes referred to as a hydroxystyrene unit hereinafter.

Examples of the resin component suited for use as the component (A-1) include, but are not limited to, a resin component of a positive resist, including a unit having a phenolic hydroxyl group such as the following structural unit (a1) and a structural unit having an acid dissociable, dissolution inhibiting group such as at least one selected from the group consisting of the following structural units (a2) and (a3), and, if necessary, an alkali-insoluble unit such as a structural unit (a4) can be used.

The resin component exhibits increased alkali solubility under an action of an acid. Namely, the action of the acid generated from an acid generator upon exposure causes cleavage of the acid dissociable, dissolution inhibiting groups from the structural unit (a2) and the structural unit (a3), and thus the alkali solubility increases in the resin which is originally insoluble in an alkali developing solution.

As a result, a chemically-amplified positive pattern can be formed by exposure and development.

Structural Unit (a1)

The structural unit (a1) is a unit which has a phenolic hydroxyl group and is preferably derived from hydroxystyrene derived from a unit represented by general formula (I) shown below:

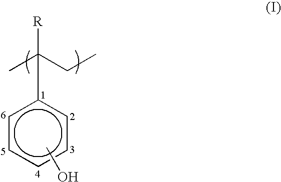

(wherein R represents —H or —CH₃).

R is not specifically limited as long as it is —H or —CH₃. The bonding position of —OH to the benzene ring is preferably the 4-position (para-position).

In view of formation of a mold, the proportion of the structural unit (a1) in the resin component constituting the component (A-1) is from 40 to 80 mol %, and preferably from 50 to 75 mol %. Ensuring that the proportion is 40 mol % or more enables an improvement of the solubility in an alkali developing solution and exertion of the effect of improving a pattern shape.

Favorable balance between the structural unit (a1) and the other structural unit(s) is achieved by controlling the proportion to 80 mol % or less.

In view of formation of a thin film on mold, the proportion of the structural unit (a1) in the resin component which forms the component (A-1) is preferably 50 mol % or more, more preferably 60 mol % or more, and still more preferably 75 mol % or more. The upper limit is not specifically limited, but is preferably 80 mol % or less. Ensuring that the proportion is within the above range enables formation of a good film on the mold in the presence of a phenolic hydroxyl group, and thus a nanostructure having a good shape can be obtained. Also, adhesion between the mold and the thin film is excellent.

Structural Unit (a2)

The structural unit (a2) is a structural unit having an acid dissociable, dissolution inhibiting group and is represented by general formula (II) shown below:

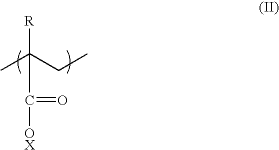

(wherein R represents —H or —CH₃, and X represents am acid dissociable, dissolution inhibiting group).

R is not specifically limited as long as it is —H or —CH₃.

The acid dissociable, dissolution inhibiting group X is an alkyl group having a tertiary carbon atom, and is an acid dissociable, dissolution inhibiting group in which a tertiary carbon atom of the tertiary alkyl group is bonded to an ester group (—C(O)O—), or a cyclic acetal group such as a tetrahydropyranyl group and a tetrahydrofuranyl group.

In addition to the acid dissociable, dissolution inhibiting groups described above, an acid dissociable, dissolution inhibiting group used in a chemically-amplified positive resist composition can also be used as the acid dissociable, dissolution inhibiting group in the present invention, namely X.

Examples of a preferable structural unit (a2) include the structural unit described in general formula (II-1) shown below.

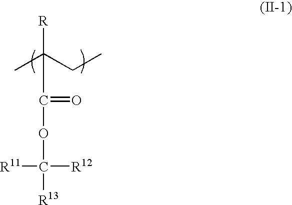

In the formula (II-1), R is as defined above, R¹¹, R¹² and R¹³ each represent, independently, a lower alkyl group (may be either straight-chain or branched, and preferably has 1 to 5 carbon atoms). Alternatively, two substituents selected from R¹¹, R¹² and R¹³ may be combined to form a monocylic or polycyclic alicyclic group (the alicyclic group preferably has 5 to 12 carbon atoms).

In the case of having no alicyclic group, for example, all of R¹¹, R¹² and R¹³ are preferably methyl groups.

In the case of having an alicyclic group, when a monocyclic alicyclic group is contained, those having a cyclopentyl group and a cyclohexyl group are preferred.

Of these polycyclic alicyclic groups, preferred examples include those represented by general formulas (II-1-1) and (II-1-2) shown below:

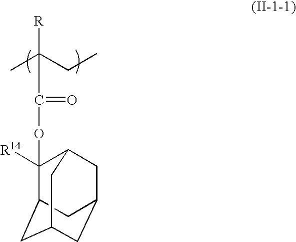

(wherein R is as defined above, and R¹⁴ represents a lower alkyl group (which may be straight-chain or branched, and preferably has 1 to 5 carbon atoms)); and

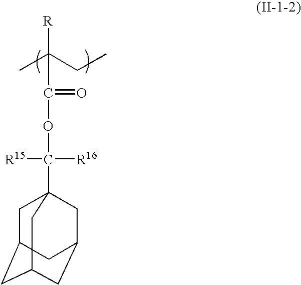

(wherein R is as defined above, R¹⁵ and R¹⁶ each represent, independently, a lower alkyl group (may be either straight-chain or branched, and preferably has 1 to 5 carbon atoms)).

The Proportion of the Structural Unit (a2) in the Resin component which forms the resin component (A-1) is preferably within a range from 5 to 50 mol %, preferably from 10 to 40 mol %, and still more preferably from 10 to 35 mol %.

Structural Unit (a3)

The structural unit (a3) is a structural unit which has an acid dissociable, dissolution inhibiting group and is represented by general formula (III) shown below:

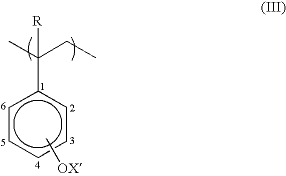

(wherein R represents —H or —CH₅, and X′ represents an acid dissociable, dissolution inhibiting group).

Examples of the acid dissociable, dissolution inhibiting group X′ include tertiary alkyloxycarbonyl groups such as a tert-butyloxycarbonyl group and a tert-amyloxycarbonyl group; tertiary alkyloxycarbonylalkyl groups such as a tert-butyloxycarbonylmethyl group and a tert-butyloxycarbonylethyl group; tertiary alkyl groups such as a tert-butyl group and a tert-amyl group; cyclic acetal groups such as a tetrahydropyranyl group and a tetrahydrofuranyl group; and alkoxyalkyl groups such as an ethoxyethyl group and a methoxypropyl group.

Of these acid dissociable, dissolution inhibiting groups, a tert-butyloxycarbonyl group, a tert-butyloxycarbonylmethyl group, a tert-butyl group, a tetrahydropyranyl group, and an ethoxyethyl group are preferred.

In addition to the acid dissociable, dissolution inhibiting groups described above, an acid dissociable, dissolution inhibiting group used in a chemically-amplified positive resist composition can be optionally used as the acid dissociable, dissolution inhibiting group X.

In the general formula (III), the bonding position of the group (—OX′) bonded to the benzene ring is not specifically limited, and is preferably the 4-position (para-position) shown in the formula.

The proportion of the structural unit (a3) in the resin component which forms the resin component (A-1) is preferably within a range from 5 to 50 mol %, preferably from 10 to 40 mol %, and still more preferably from 10 to 35 mol %.

Structural Unit (a4)

The structural unit (a4) is an alkali-insoluble unit, and is represented by general formula (IV) shown below:

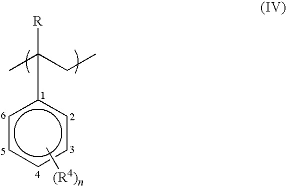

(in the formula (IV), R represents —H or —CH₃, R⁴ represents a lower alkyl group, and n represents an integer of 0 or 1 to 3).

The lower alkyl group represented by R⁴ in the formula (IV) may be straight-chain or branched, and preferably has 1 to 5 carbon atoms.

n represents an integer of 0 or 1 to 3, and is preferably 0.

The proportion of the structural unit (a4) in the resin component which forms the resin component (A-1) is preferably within a range from 1 to 40 mol %, and more preferably from 5 to 25 mol %. Ensuring that the proportion is 1 mol % or more enables exertion of the enhanced effect of improving the shape (particularly improving thickness loss described hereinafter), whereas ensuring that the proportion is 40 mol % or less enables a more favorable balance to be achieved with the other structural units.

The component (A-1) essentially contains at least one selected from the group consisting of the structural unit (a1), the structural unit (a2), and the structural unit (a3), and may optionally contain a structural unit (a4). Also, a copolymer containing all of these units may be used, or a mixture of polymers each having at least one of these units may be used. Alternatively, they may be used in combination.

The component (A-1) can also optionally contain something other than the structural units (a1), (a2), (a3), and (a4), and the proportion of these structural units (a1), (a2), (a3), and (a4) is preferably 80 mol % or more, and more preferably 90 mol % or more (most preferably 100 mol %).

One or more kinds of copolymer (1) containing the structural units (a1) and (a3), one or more kinds of copolymer (2) containing the structural units (a1), (a2) and (a4) are used, or a mixture of copolymer (1) and (2) is most preferred, because the effect is simply obtained. It is also preferred in view of an improvement in heat resistance. The mass ratio of the copolymer (1) to copolymer (2) upon mixing is, for example, from 1/9 to 9/1, and preferably from 3/7 to 7/3.

The polystyrene equivalent weight average molecular weight determined using GPC of the component (A-1) is more than 2,000, preferably within a range from more than 2,000 to 30,000, more preferably from 3,000 to 30,000, and still more preferably from 5,000 to 20,000.

The component (A-1) can be obtained by polymerizing a material monomer of the structural units using a known method.

A resin component (A-1′), other than the above components, suited for use as the component (A-1) is preferably a resin component containing a (meth)acrylate ester resin, and more preferably a resin component composed of a (meth)acrylate ester resin, because a mold having lower etching resistance can be formed.

In the (meth)acrylate ester resin, a resin containing a structural unit (a5) derived from a (meth)acrylate ester having an acid dissociable, dissolution inhibiting group is preferred.

In the structural unit (a5), a methyl group or a lower alkyl group is bonded at the α-position of the methacrylate ester.

The lower alkyl group bonded at the α-position of the methacrylate ester is an alkyl group of 1 to 5 carbon atoms, and preferably a straight-chain or branched alkyl group, and examples thereof include a methyl group, an ethyl group, a propyl group, an isopropyl group, an n-butyl group, an isobutyl group, a tert-butyl group, a pentyl group, an isopentyl group, and a neopentyl group. Of these groups, a methyl group is preferred from an industrial point of view.

In the structural unit (a5), a hydrogen atom or a methyl group is preferably bonded at the α-position of the methacrylate ester, and more preferably a methyl group.

The acid dissociable, dissolution inhibiting group in the structural unit (a5) is a group having the effect that renders the entire component (A-1′) alkali-insoluble prior to exposure, and then following dissociation by the action of an acid generated from the component (B) after exposure, causes the entire component (A-1′) to change to an alkali-soluble state.

As the acid dissociable, dissolution inhibiting group, it is possible to use, for example, those selected appropriately from among various acid dissociable, dissolution inhibiting groups proposed in the resin of a resist composition for an ArF eximer laser. Generally, a group capable of forming a cyclic or chain-like tertiary alkyl ester with a carboxyl group of (meth)acrylic acid, and a cyclic or chain-like alkoxyalkyl group with a carboxyl group of (meth)acrylic acid are the most widely known. The term “(meth)acrylate ester” is a generic term that includes either one of, or both, an acrylate ester and a methacrylate ester.

Herein, a “group capable of forming a tertiary alkyl ester” is a group in which an ester is formed by substituting the hydrogen atom of the carboxyl group of acrylic acid. Namely, it describes a structure in which the tertiary carbon atom of the chain-like or cyclic tertiary alkyl group is bonded to the oxygen atom at the terminal of the carbonyloxy group (—C(O)—O—) of the acrylate ester. In this tertiary alkyl ester, the action of the acid causes cleavage of the bond between the oxygen atom and the tertiary carbon atom.

The tertiary alkyl group is an alkyl group containing the tertiary carbon atom.

Examples of the group that constitutes the chain-like tertiary alkyl ester include a tert-butyl group and a tert-amyl group.

Examples of the group that constitutes the cyclic tertiary alkyl ester are the same as those listed in the “acid dissociable, dissolution inhibiting group having an alicyclic group” described below.

A “cyclic or chain-like alkoxyalkyl group” forms an ester by substituting the hydrogen atom of the carboxyl group with an alkoxyalkyl group. Namely, it forms a structure in which the alkoxyalkyl group is bonded to the oxygen atom at the terminal of the carbonyloxy group (—C(O)—O—) of the acrylate ester. In this structure, the action of the acid causes cleavage of the bond between the oxygen atom and the alkoxyalkyl group.

Examples of the cyclic or chain-like alkoxyalkyl group include a 1-methoxymethyl group, a 1-ethoxyethyl group, a 1-isopropoxyethyl, a 1-cyclohexyloxyethyl group, a 2-adamantoxymethyl group, a 1-methyladamantoxymethyl, group, a 4-oxo-2-adamantoxymethyl group, a 1-adamantoxyethyl group, and a 2-adamantoxyethyl group.

The structural unit (a5) is preferably a structural unit having an acid dissociable, dissolution inhibiting group which has a cyclic, particularly aliphatic cyclic group.

In this description, the term “aliphatic” is a relative concept used in relation to the aromatic group, and defines a group or compound or the like that contains no aromaticity. The term “aliphatic cyclic group” means a monocyclic group or polycyclic group that contains no aromaticity.

The aliphatic cyclic group may be either monocyclic or polycyclic and, for example, it is possible to use those selected appropriately from various aliphatic cyclic groups proposed for an ArF resist, for example. In view of etching resistance, a monocyclic alicyclic group is preferred. Also, the alicyclic group is preferably a hydrocarbon group, and particularly preferably a saturated hydrocarbon group (alicyclic group).

Examples of the monocyclic alicyclic group include groups in which one hydrogen atom has been removed from a cycloalkane. Examples of the polycyclic alicyclic group include groups in which one hydrogen atom has been removed from a bicycloalkane, tricycloalkane, or tetracycloalkane.

Specific examples of the monocyclic alicyclic group include a cyclopentyl group and a cyclohexyl group. Examples of the polycyclic alicyclic group include groups in which one hydrogen atom has been removed from a polycycloalkane such as adamantane, norbornane, isobornane, tricyclodecane, or tetracyclododecane.

Of these groups, an adamantyl group in which one hydrogen atom has been removed from adamantane, a norbornyl group in which one hydrogen atom has been removed from norbornane, a tricyclodecanyl group in which one hydrogen atom has been removed from tricyclodecane, and a tetracyclododecanyl group in which one hydrogen atom has been removed from tetracyclododecane are preferred from an industrial point of view.

More specifically, the structural unit (a5) is preferably at least one kind selected from among those of general formulas (I′) to (III′) shown below.

A unit derived from a (meth)acrylate ester in which the ester portion has the above cyclic alkoxyalkyl group, specifically at least one kind selected from among units derived from an aliphatic polycyclic alkyloxy lower alkyl (meth)acrylate ester which may have a substituent such as a 2-adamantoxymethyl group, a 1-methyladamantoxymethyl group, a 4-oxo-2-adamantoxymethyl group, a 1-adamantoxyethyl group, or a 2-adamantoxyethyl group is preferred.

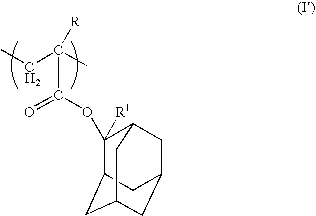

(in the formula (I′), R represents a hydrogen atom or a lower alkyl group, and R¹ represents a lower alkyl group);

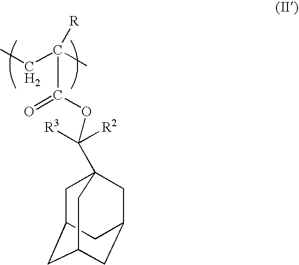

(in the formula (II′), R represents a hydrogen atom dr a lower alkyl group, and R² and R³ each represent, independently, a lower alkyl group); and

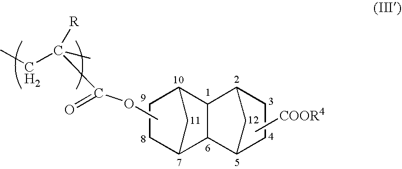

(in the formula (III′), R represents a hydrogen atom dr a lower alkyl group, and R⁴ represents a tertiary alkyl group).

For the hydrogen atom or lower alkyl group of R in the formulas (I′) to (III′), the same description applies as that used for the hydrogen atom or lower alkyl group bonded at the α-position of the (meth)acrylate ester.

The lower alkyl group represented by R¹ is preferably a straight-chain or branched chain alkyl group of 1 to 5 carbon atoms, and specific examples thereof include a methyl group, an ethyl group, a propyl group, an isopropyl group, an n-butyl group, an isobutyl group, a pentyl group, an isopentyl group, and a neopentyl group. Of these groups, a methyl group and an ethyl group are preferred for the reason of industrial availability.

It is preferred that the lower alkyl group represented by R² and R³ each represent, independently, a straight-chain or branched chain alkyl group of 1 to 5 carbon atoms. It is preferred from an industrial point of view that both R² and R³ are methyl groups. Specific examples of the formula (II′) include a structural unit derived from 2-(1-adamantyl)-2-propyl acrylate.

R⁴ in the formula (III′) is preferably a chain-like tertiary alkyl group or a cyclic tertiary alkyl group, and is preferably of 4 to 7 carbon atoms. Examples of the chain-like tertiary alkyl group include a tert-butyl group and a tert-amyl group, of which a tert-butyl group is preferred from an industrial point of view.

The cyclic tertiary alkyl group is the same as that described in the “acid dissociable, dissolution inhibiting group containing the aliphatic cyclic group”, and examples thereof include a 2-methyl-2-adamantyl group, a 2-ethyl-2-adamantyl group, a 2-(1-adamantyl)-2-propyl group, a 1-ethylcyclohexyl group, a 1-ethylcyclopentyl group, a 1-methylcyclohexyl groups and a 1-methylcyclopentyl group.

The group —COOR⁴ may be bonded at the 3- or 4-position of the tetracyclododecanyl group shown in the formula, but the bonding position cannot be specified. Also, the carboxyl group residue in the acrylate structural unit may be bonded at the 8- or 9-position shown in the formula, similarly.

The structural unit (a5) can be used either alone, or in combinations of two or more different structural units.

The proportion of the structural unit (a5) in the (meth)acrylate ester resin component, relative to the combined total of all the structural units that constitute the component (A-1′), is preferably within a range from 20 to 60 mol %, more preferably from 30 to 50 mol %, and most preferably from 35 to 45 mol %. Ensuring that this proportion is at least as large as the lower limit of the above range enables formation of a pattern, whereas ensuring that the proportion is no more than the upper limit enables a more favorable balance to be achieved with the other structural units.

The (meth)acrylate ester resin included in the resin component as the component (A-1′) preferably contains, in addition to the structural unit (a5), a structural unit (a6) derived from a lactone ring-containing acrylate ester.

The structural unit (a6) is effective in enhancing adhesion of a resist film to a substrate and in enhancing hydrophilicity with a developing solution. It is also possible to form a thin film having high adhesion with the mold.

In the structural unit (a6), a lower alkyl group or a hydrogen atom is bonded to the carbon atom at the α-position. The lower alkyl group bonded to the carbon atom at the α-position is the same as the lower alkyl group in the description for the structural unit (a5), and is preferably a methyl group.

The structural unit (a6) includes a structural unit in which a monocyclic group composed of a lactone ring or a polycyclic group containing a lactone ring is bonded to the ester side chain portion of the acrylate ester. Herein, the term “lactone ring” refers to a single ring containing a —O—C(O)— structure, and this ring is counted as the first ring. Accordingly, the case in which the only ring structure is the lactone ring is referred to as a monocyclic group, and groups containing other ring structures are described as polycyclic groups regardless of the structure of the other rings.

Examples of the structural unit (a6) include those having a monocyclic group in which one hydrogen atom has been removed from γ-butyrolactone or a polycyclic group in which one hydrogen atom has been removed from a lactone ring-containing bicycloalkane.

More specifically, the structural unit (a6) is preferably at least one kind selected from among units of general formulas (IV′) to (VII′) shown below:

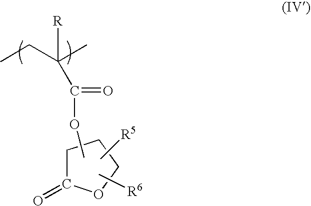

(in the formula (IV′), R represents a hydrogen atom or a lower alkyl group, and R⁵, R⁶ each represent, independently, a hydrogen atom or a lower alkyl group);

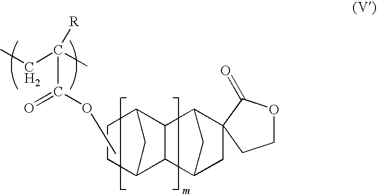

(in the formula (V′), R represents a hydrogen atom or a lower alkyl group, and m is 0 or 1);

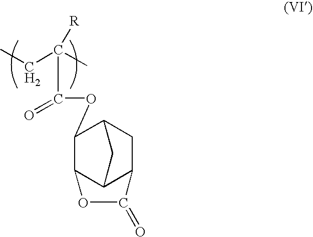

(in the formula (VI′), R represents a hydrogen atom or a lower alkyl group); and

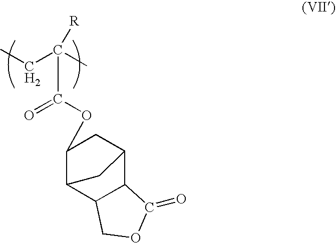

(in the formula (VII′), R represents a hydrogen atom or a lower alkyl group).

In the formulas (IV′) to (VII′), the description of R is the same as those of R in the formulas (I′) to (III′).

In the formula (IV′), R⁵, R⁶ each represent, independently, a hydrogen atom or a lower alkyl group, and preferably a hydrogen atom. In R⁵ and R⁶, the lower alkyl group is preferably a straight-chain or branched chain alkyl group of 1 to 5 carbon atoms, and examples thereof include a methyl group, an ethyl group, a propyl group, an isopropyl group, an n-butyl group, an isobutyl group, a tert-butyl group, a pentyl group, an isopentyl group, and a neopentyl group. Of these groups, a methyl group is preferred from an industrial point of view.

Of the structural units represented by general formulas (IV′) to (VII′), a structural unit represented by general formula (IV′) is preferable because of inexpensive price and from an industrial point of view. Of the structural unit represented by general formula (IV′), the most preferred structural unit is an α-methacryloyloxy-γ-butyrolactone in which R represent a methyl group, R⁵ and R⁶ represent a hydrogen atom, and the position of an ester bond of a methacrylate ester and γ-butyrolactone is at the lactone cyclic α-position.

The structural unit (a6) can be used either alone, or in combinations of two or more different structural units.

The proportion of the structural unit (a6) in the (meth)acrylate ester resin component, relative to the combined total of all the structural units that constitute the component (A-1′), is preferably within a range from 20 to 60 mol %, more preferably from 20 to 50 mol %, and most preferably from 30 to 45 mol %. Ensuring that this proportion is at least as large as the lower limit of the above range enables an improvement in lithography characteristics, whereas ensuring that the proportion is no more than the upper limit enables a more favorable balance to be achieved with the other structural units.

In the component (A-1′), the (meth)acrylate ester resin component preferably contains, in addition to the structural unit (a5) or the structural units (a5) and (a6), a structural unit (a7) derived from an acrylate ester having a polar group-containing polycyclic group.

Inclusion of the structural unit (a7) enhances the hydrophilicity of the entire (meth)acrylate ester resin component, thereby improving the affinity with the developing solution, improving the alkali solubility within the exposed portions, and contributing to an improvement in the resolution. Also, it enables a thin film having high adhesion to a mold to be formed.

In the structural unit (a7), a lower alkyl group or hydrogen atom is bonded to the carbon atom at the α-position the lower alkyl group bonded to the carbon atom at the α-position is the same as the lower alkyl group in the description for the structural unit (a5), and is preferably a methyl group.

Examples of the polar group include a hydroxyl group, a cyano group, a carboxy group, and an amino group, of which a hydroxyl group is preferred.

It is possible to use, as the polycyclic group, those selected appropriately from polycyclic groups among aliphatic cyclic groups listed in the “acid dissociable, dissolution inhibiting group containing an aliphatic cyclic group” in the unit (a5).

The structural unit (a7) is preferably at least one kind selected from among units of general formulas (VIII′) to (IX′) shown below:

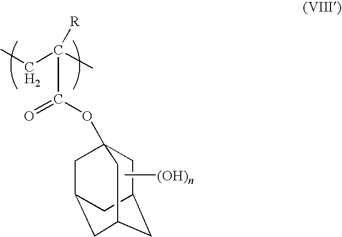

(in the formula (VIII′), R represents a hydrogen atom or a lower alkyl group, and n represents an integer from 1 to 3).

R in the formula (VIII′) is the same as in the formulas (I′) to (III′).

It is preferred that n is 1, and a hydroxyl group is bonded to the 3-position of an adamantyl group.

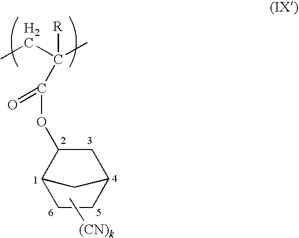

(in the formula (IX′), R represents a hydrogen atom or a lower alkyl group, and k represents an integer from 1 to 3).

R in the formula (IX′) is the same as in the formulas (I′) to (III′).

It is preferred that k is 1. It is also preferred that a cyano group is bonded to the 5- or 6-position of a norbornanyl group.

The structural unit (a7) can be used alone, or in combinations of two or more different structural units.

The proportion of the structural unit (a7) in the (meth)acrylate ester resin component, relative to the combined total of all the structural units that constitute the component (A-1′), is preferably within a range from 10 to 50 mol %, more preferably from 15 to 40 mol %, and still more preferably from 20 to 35 mol %. Ensuring that this proportion is at least as large as the lower limit of the above range enables an improvement in lithography characteristics, whereas ensuring that the proportion is no more than the upper limit enables a more favorable balance to be achieved with the other structural units.

The (meth)acrylate ester resin component may contain a structural unit other than the structural units (a5) to (a7), and the combined total of the structural units (a5) to (47) is preferably from 70 to 100 mol %, and more preferably from 80 to 100 mol %, relative to the combined total of all the structural units that constitute the component (A-1′).

The (meth)acrylate ester resin component may contain a structural unit (a8) other than the structural units (a51 to (a7).

The structural unit (a8) is not specifically limited, as long as it is a structural unit that does not belong to the structural units (a5) to (a7).

For example, a structural unit which contains a polycyclic aliphatic hydrocarbon group and is also derived from a (meth)acrylate ester is preferred. It is possible to use, as the polycyclic aliphatic hydrocarbon group, those selected appropriately from polycyclic groups among aliphatic cyclic groups listed in the “acid dissociable, dissolution inhibiting group containing an aliphatic cyclic group”. At least one kind selected from among a tricyclodecanyl group, an adamantyl group, a tetracyclododecanyl group, a norbornyl group, and an isobornyl group is particularly preferred for reasons such as industrial availability. The structural unit (a8) is most preferably an acid non-dissociable group.

Specific examples of the structural unit (a5) include those having structures of the formulas (X) to (XII) shown below:

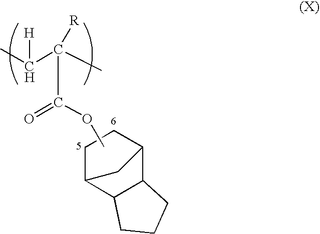

(wherein R represents a hydrogen atom or a lower alkyl group).

This structural unit is usually obtained as a mixture of isomers at the 5- or 6-position.

In the formula (X), the description of R is the same as in the formulas (I′) to (III′).

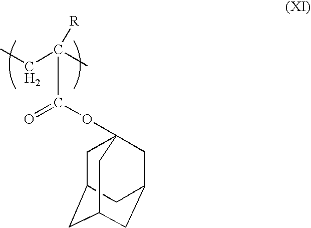

(wherein R represents a hydrogen atom or a lower alkyl group).

In the formula (XI), the description of R is the same as in the formulas (I′) to (III′).

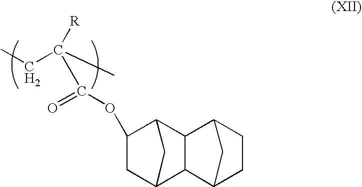

(wherein R represents a hydrogen atom or a lower alkyl group).

In the formula (XII), the description of R is the same as in the formulas (I′) to (III′).

In the case of containing the structural unit (a8), the proportion of the structural unit (a8) in the (meth) acrylate ester resin component, relative to the combined total of all the structural units that constitute the component (A-1′), is preferably within a range from 1 to 25 mol %, and more preferably from 5 to 20 mol %.

The (meth)acrylate ester resin component is preferably a copolymer containing at least structural units (a5), (a6), and (a7). Examples of the copolymer include copolymers composed of the structural units (a5), (a6) and (a7), and copolymers composed of the structural units (a5), (a6), (a7) and (a8).

The (meth)acrylate ester resin component can be obtained, for example, by a conventional radical polymerization of the monomers which have each of the structural units, using a radical polymerization initiator such as azobisisobutyronitrile (AIBN).

In the (meth)acrylate ester resin component, the acid dissociable, dissolution inhibiting group in the unit (a5) is dissociated by an acid generated from the component (B) t produce a carboxylic acid. A thin film having high adhesion to the mold can be formed by the presence of the carboxylic acid.

The weight average molecular weight (polystyrene equivalent weight average molecular weight determined using gel permeation chromatography, the same shall apply hereinafter) of the (meth)acrylate ester resin component is, for example, 30,000 or less, preferably 20,000 or less, more preferably 12,000 or less, and most preferably 10,000 or less.

The lower limit is not specifically limited, add is preferably 4000 or more, and still more preferably 5,000 or more, in view of suppression of pattern collapse and improvement in resolution.

### <Component (A-2)>

The component (A-2) can be used without any limitation, as long as it has a molecular weight within a range from 500 to 2,000, has a hydrophilic group, and also has an acid dissociable, dissolution inhibiting group X or X′ as listed in the description of (A-1).

Specific examples thereof include those in which a portion of the hydrogen atoms in the hydroxyl group of a compound containing plural phenol skeletons are substituted with the acid dissociable, dissolution inhibiting group X or X′.

The component (A-2) is preferably a component in which a portion of the hydrogen atoms in the hydroxyl group of a low molecular weight phenol compound known as a sensitizer or a heat resistance improver in a non-chemically-amplified g-ray or i-ray resist are substituted with the acid dissociable, dissolution inhibiting group, and a component selected from among these components can be optionally used.

Examples of the low molecular weight phenol compound include, but are not limited to:

two, three, and four benzene ring-type formalin condensates of phenols such as bis(4-hydroxyphenyl)methane, bis(2,3,4-trihydroxyphenyl)methane, 2-(4-hydroxyphenyl)-2-(4′-hydroxyphenyl)propane, 2-(2,3,4-trihydroxyphenyl)-2-(2′,3′,4′-trihydroxyphenyl)propane, tris(4-hydroxyphenyl)methane, bis(4-hydroxy-3,5-dimethylphenyl)-2-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, bis(4-hydroxy-2,5-dimethylphenyl)-3,4-dihydroxyphenylmethane, bis(4-hydroxy-3-methylphenyl)-3,4-dihydroxyphenylmethane, bis(3-cyclohexyl-4-hydroxy-6-methylphenyl)-4-hydroxyhenylmethane, bis(3-cyclohexyl-4-hydroxy-6-methylphenyl)-3,4-dihydLoxyphenylmethane, 1-[1-(4-hydroxyphenyl)isopropyl]-4-[1,1-bis(4-hydroxphenyl)ethyl]benzene, phenol, m-cresol, p-cresol, and xylenol.

The acid dissociable, dissolution inhibiting group is not also specifically limited, and examples thereof include those described above.

### <Acid Generator (B)>

It is possible to use, as the component (B), those which are appropriately selected from among conventionally known acid generators in a chemically-amplified photoresist. Specific examples of diazomethane-based acid generators include bis(isopropylsulfonyl)diazomethane, bis(p-toluenesulfonyl)diazomethane, bis(1,1-dimethylethylsulfonyl)diazomethane, bis(cyclohexylsulfonyl)diazomethane, and bis(2,4-dimethylphenylsulfonyl)diazomethane.

Specific examples of onium salts include diphenyliodoniumtrifluoromethane sulfonate, (4-methoxyphenyl)phenyliodoniumtrifluoromethane sulfonate, bis(p-tert-butylphenyl)iodoniumtrifluoromethane sulfonate, triphenylsulfoniumtrifluoromethane sulfonate, (4-methoxyphenyl)diphenylsulfoniumtrifluoromethane sulfonate, (4-methylphenyl)diphenylsulfoniumnonafluorobutane sulfonate, (p-tert-butylphenyl)diphenylsulfoniumtrifluoromethane sulfonate, diphenyliodoniumnonafluorobutane sulfonate, bis(p-tert-butylphenyl)iodoniumnonafluorobutane sulfonate, and triphenylsulfoniumnonafluorobutane sulfonate. Of those onium salts, an onium salt containing fluorinated alkylsulfonate ions as an anion are preferred.

Examples of the oxime sulfonate compound include α-(methylsulfonyloxyimino)-phenylacetonitrile, α-(methylsulfonyloxyimino)-p-methoxyphenylacetonitrile, α-(trifluoromethylsulfonyloxyimino)-phenylacetonitrile, α-(trifluoromethylsulfonyloxyimino)-p-methoxyphenyladetonitrile, α-(ethylsulfonyloxyimino)-p-methoxyphenylacetonitrile, α-(propylsulfonyloxyimino)-p-methylphenylacetonitrile, and α-(methylsulfonyloxyimino)-p-bromophenylacetonitrile. Of these compounds, α-(methylsulfonyloxyimino)-p-methoxyphenylacetonitrile is preferred.

As the component (B), an acid generator may be used either alone, or in combinations of two or more different acid generators.

The content of the component (B) is from 1 to 20 parts by mass, and more preferably from 2 to 10 parts by mass, relative to 100 parts by mass of the component (A-1) and/or the component (A-2). Ensuring that the content is at least as large as the lower limit of the above ranges enables formation of a pattern having a favorable shape, whereas ensuring that the proportion is no more than the upper limit enables preparation of a uniform solution and improved storage stability.

The composition for formation of a mold of the present invention can further contain a nitrogen-containing organic compound as an optional component (C) so as to improve mold pattern shape and post exposure stability of the latent image formed by the pattern-wise exposure of the resist layer.

Since various nitrogen-containing organic compounds are proposed, the nitrogen-containing organic compound may be optionally used from among known ones. Of these nitrogen-containing organic compounds, an amine, particularly a secondary lower aliphatic amine or a tertiary lower aliphatic amine is preferred.

Herein, the lower aliphatic amine means an amine of an alkyl or an alkyl alcohol of 5 or less carbon atoms. Examples of the secondary or tertiary amine include trimethylamine, diethylamine, triethylamine, di-n-propylamine, tri-n-propylamine, tripentylamine, diethanolamine, and triethanolamine, of which a tertiary alkanolamine such as triethanolamine is preferred.

These amines may be used either alone, or in combinations of two or more different amines.

These amines are usually used in the amount within a range from 0.01 to 5.0 parts by mass, relative to 100 parts by mass of the component (A-1) and/or the component (A-2).

Furthermore, in order to prevent any deterioration in sensitivity caused by the addition of the above component (C), and to improve the mold pattern shape and post exposure stability of the latent image formed by the pattern-wise exposure of the resist layer, an organic carboxylic acid, or a phosphorus oxo acid or derivative thereof may also be further added to the resist composition as an optional component (D). The component (C) and the component (D) can be used in combination, or either one can also be used alone.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or the derivatives such as ester thereof, including phosphoric acid, di-n-butyl phosphate, and diphenyl phosphate; phosphonic acid or the derivatives such as ester thereof, including phosphonic acid, dimethyl phosphonate, di-n-butyl phosphonate, phenylphosphonic acid, diphenyl phosphonate, and dibenzyl phosphonate; and phosphinic acid or the derivatives such as ester thereof, including phosphinic acid and phenylphosphinic acid, of which phosphonic acid is particularly preferred.

The component (D) is typically used in an amount within a range from 0.01 to 5.0 parts by mass, relative to 100 parts by mass of the component (A-1) and/or the component (A-2).

Other miscible additives can also be optionally added to the resist composition if necessary, and examples include additive resins for improving the properties of the coating film of the composition for formation of a mold, surfactants for improving the coating properties, dissolution inhibitors, plasticizers, stabilizers, colorants, and halation prevention agents.

### <Organic Solvent>

The composition for formation of a mold of the present invention can be prepared by dissolving the materials of the respective components in an organic solvent.

The organic solvent may be any solvent capable of dissolving the various components used to generate a uniform solution, and one or more solvents selected from known materials conventionally used as solvents for chemically-amplified compositions can be used.

Specific examples of the solvent include γ-butyrolactone; ketones such as acetone, methyl ethyl ketone, cyclohexanone, methyl isoamyl ketone, and 2-heptanone; polyhydric alcohols and derivatives thereof, such as ethylene glycol, ethylene glycol monoacetate, diethylene glycol, diethylene glycol monnoacetate, propylene glycol, propylene glycol monoacetate, propylene glycol monomethyl ether acetate (PGMEA), dipropylene glycol, or the monomethyl ether, monoethyl ether, monopropyl ether, monobutyl ether, or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents may de used either alone, or as a mixed solvent of two or more different solvents.

Although there are no particular restrictions on the amount of the organic solvent used, the amount should be set at a concentration that enables favorable application of the solution to a substrate.

As the composition for formation of a mold, in addition to those listed in the above embodiments, a radiation-sensitive composition which is known as a resist composition and contains an organic compound having a hydrophilic group can be preferably used.

For example, if not a chemically-amplified composition, a radiation-sensitive composition containing an alkali-soluble resin, such as a novolak resin and a hydroxystyrene resin, and a photosensitive component such as a naphthoquinonediazide group-containing compound can also be used as the composition for formation of a mold. If necessary, a sensitizer can also be added. When a low molecular compound having a molecular weight of 500 or more and a phenolic hydroxyl group is used as the sensitizer, the compound also contributes to the effect as an organic compound which is an essential component in the composition for formation of a mold of the present invention.

### [Mold]

The mold of the present invention is not specifically limited so long as it does not depart from the purports of the present invention. For example, it is possible to employ a mold designed by a lithography method, a mold produced by contact printing/imprinting, a mold produced by mechanical microfabrication, a mold produced by LIGA (Lithographie, Galvanoformung, Abformung), a mold produced by beam writing, a nano-mold composite in which a mold made of the composition for formation of a mold of the present invention and a nanostructure made of a thin film material described hereinafter are combined to entirely form a mold, and molds in which the surfaced of these molds are subjected to a physical treatment and/or a chemical treatment. Examples of the physical treatment and/or chemical treatment include abrasion, an adhesion operation such as formation of a thin film on the surface, a plasma treatment, a solvent treatment, chemical decomposition of the surface, a heat treatment, and a stretching treatment.

Of these molds, a mold designed by a lithography method is more preferred.

The shape of the mold can be appropriately decided according to the shape of the objective nanostructure, and it is possible to employ a rectangle, a column, a line, a network structure or a branched structure thereof, a polygon, a composite/repeated structure thereof, a circuit-shaped structure observed in an integrated circuit, and a lattice shape.

The method for formation of a mold is not limited to a microfabrication technology through a patterning technique using a lithography method. For example, it is also possible to utilize a minute structure made by transferring a microfabricated substrate, which is pressed in advance, to another substrate. The latter method can be applied whether or not the composition for formation of a mold has radiation sensitivity.

The thickness of the mold (height of mold) in the present invention is not specifically limited, and can be appropriately adjusted according to the shape and size of the nanostructure to be obtained. The thickness cannot be unconditionally limited, and, for example, can be decided within a range from about several tens of nanometers to several micrometers, and preferably from 100 to 500 nm.

The pattern width of the mold (width in the direction perpendicular to the height) can be appropriately adjusted according to the shape of the mold to be made, the resist material to be used, the wavelength of light to be irradiated, the aspect ratio of the width to the height, and distance from an adjacent pattern. Specifically, the pattern width can be adjusted within a range from several tens of nanometers to several micrometers.

### <Method for Formation of Mold>

Although the method for formation of a mold is not specifically limited, the mold is preferably formed by a lithography method using a radiation-sensitive composition as a composition for formation of a mold. The lithography method is not specifically limited, and a known lithography method can be used. For example, a light lithography method, an X-ray lithography method, and an electron beam lithography method can be preferably used.

For example, the mold is formed by the lithography method, using the composition for formation of a mold which is described in the above embodiment, in the following manner.

Namely, the composition for formation of a mold described in the above embodiment is first applied to a substrate using a spin coater, and prebaking is then conducted under temperature conditions of 80 to 150° C., and preferably 90 to 150° C., for 40 to 120 seconds, and preferably 60 to 90 seconds, thus forming a film. This film is selectively exposed through a desired mask pattern, or by writing, and then PEB (post exposure baking) is conducted under temperature conditions of 80 to 150° C., for 40 to 120 seconds, and preferably for 60 to 90 seconds. Subsequently, a developing treatment is conducted using an alkali developing solution such as an aqueous 0.1 to 10 mass % solution of tetramethylammonium hydroxide. In this manner, a mold pattern that is faithful to the mask pattern can be obtained.

An organic or inorganic anti-reflective film can also be provided between the substrate and the applied layer of the composition for formation of a mold.

The wavelength of radiation used to form a radiation mold pattern by a lithography method can be selected according to the composition for formation of a mold to be used, and is not specifically limited.

Specifically, the wavelength varies depending on light absorbance of the applied composition for formation of a mold, the thickness of the film formed of the composition for formation of a mold, and the size of a mold structure to be written. Therefore, the wavelength cannot be unconditionally limited, and can be appropriately selected within a range from a far ultraviolet range of 300 nm or less to an extreme ultraviolet range and X-ray range of several nanometers. For example, KrF, ArF, an electron beam, EUV (extreme ultraviolet rays having a wavelength of about 13.5 nm), and X-rays can be used. In the case of a radiation-sensitive composition containing the above component (A-1) or (A-2) and (B) an acid generator, a minute mold can be preferably obtained using any of KrF, ArF, an electron beam, EUV, and X-rays. In contrast, in the case of a radiation-sensitive composition other than the above chemically-amplified composition, a minute pattern of 200 nm or less is formed using an electron beam, and thus it is preferable.

Also, the treatment conditions in the case of forming a mold pattern using a lithography method are not limited to those described in the above embodiment, and can be appropriately set according to the constitution of the composition for formation of a mold.

On the surface of the mold formed using the composition for formation of a mold in the present invention, a hydrophilic group derived from the composition for formation of a mold is present. Therefore, the hydrophilic group can be used as a functional group (reactive group) which interacts with the material of the thin film. Furthermore, another reactive group may also be introduced into the surface of a mold. For example, when the thin film is composed of the metal oxide, the reactive group is preferably a hydroxyl group, preferably a phenolic hydroxyl group or an alcoholic hydroxyl group; an ester group such as lactone; and/or a carboxy group.

As the method for introducing a reactive group into the surface of a mold, a known method for introducing a reactive group (for example, a known method for introducing a hydroxyl group, or a carboxy group) can be used. For example, the hydroxyl group can be introduced by adsorbing mercaptoethanol onto the surface of a mold. In the present invention, since an additional step of introducing a hydroxyl group and/or a carboxy group into the surface of the mold is not necessary, a nanostructure or a nanomaterial can be advantageously obtained in fewer steps.

The amount of reactive groups, existing in the surface of a mold per unit area exerts an influence on the density of the thin layer formed on the mold. For example, it is preferable that the amount of the reactive group is from 5.0×10¹³ to 1.0×10¹⁵ equivalents/cm², and more preferably from 1.0×10¹⁴ to 15.0×10¹⁴ equivalents/cm² so as to form a excellent metal oxide layer on the mold.

### <Method for Removing Mold>

As the method for removing a mold, conventionally known methods for removing a mold can be widely used. Of these methods, at least one treatment method selected from the group consisting of plasma, ozone oxidation, elution, and firing methods is preferred, and a plasma treatment method is more preferred.

As a result of removal of the mold, a nanostructure (metal oxide structure, etc.) with a minute pattern having a controlled size by controlling the film thickness is obtained.

The step of removing a mold can be conducted simultaneously or separately, in case that plural molds are provided. When the step is separately conducted, it is preferred to be sequentially removed from the mold which lies inside or on lower bide. Furthermore, it is not necessary to remove the entire mold, when plural molds are provided. Also, the entire portion of one mold may be completely removed, or only a portion thereof may be removed. In the case of removing a portion of the mold, the proportion of the mold to be removed is preferably from 1 to 99%, and more preferably from 5 to 95%. In the case of removing a portion of the mold as described above, the resulting nano-mold composite partially contains the mold. The nanostructure in such a state can be used as is. As a matter of course, it is also, possible to further fabricate (process), or to further fabricate (process) after transferring to another substrate.

In the present invention, in the step of removing a portion of the thin film which is conducted before removing the mold, a portion or all of the mold may be removed. For example, when the thin film is removed by etching, a portion or all of the mold can be removed in the step of removing a portion of the thin film if the constitution of the composition for formation of a mold is a constitution having lower etching resistance than that of the material for forming the thin film. It is preferred because the mold can be efficiently removed and also thickness loss of the thin film in the following step of removing the mold is suppressed.

### [Thin Film]

The thin film to be provided on the surface of a mold is not specifically limited, as long as it does not depart from the purports of the present invention. Examples of the material of the thin film include at least one kind selected from the group consisting of a metal oxide, an organic/metal oxide composite, an organic compound, and an organic/inorganic composite, of which a metal oxide and an organic/metal oxide composite are preferred. Of these materials, a material containing an oxide of a metal such as silicon (metallic silicon), titanium, zirconium, or hafnium is preferred.

The thin film is preferably made of silica, because it is suited for use in various thin films such as an etching-resistant material and an insulating film which are used in the production of semiconductor devices and liquid crystal devices.

For example, it is possible to preferably use a thin film material of an amorphous metal oxide having a structured in which a portion corresponding to an organic component of ah organic/metal oxide composite, in which the organic component is dispersed molecularly, is removed, as described in Japanese Unexamined Patent Application, First Publication No. 2002-338211. Also, as described in International Publication WO 03/095193, it is possible to preferably use a thin film material composed of a polymer thin film layer in which a hydroxyl group or carboxy group is present on the surface, and a metal oxide thin film layer or an organic/metal oxide composite thin film layer (organic/metal oxide composite) which is coordinately or covalently bonded with the polymer thin film layer using the hydroxyl group or carboxy group. Also, as described Japanese Unexamined Patent Application, First Publication No. Hei 10-249985, a metal oxide thin film, an organic compound thin film, and a composite thereof (organic/metal oxide composite can also be preferably used.

The organic matter used in the thin film is preferably a polyanion and/or a polycation which is a polymer having a charge. The polyanion has a functional group capable of being negatively charged, such as polyglutamic acid, sulfonic acid, sulfuric acid, or carboxylic acid, and preferred examples thereof include polystyrenesulfonic acid (PSS), polyvinylsulfuric acid (PVS), dextransulfuric acid, chondroitin sulfate, polyacrylic acid (PAA), polymethacrylic acid (PMA), polymaleic acid, and polyfumaric acid. Of these polyanions, polystyrenesulfonic acid (PSS) and polymaleic acid are particularly preferred. In contrast, the polycation has a functional group capable of being positively charged such as a quaternary ammonium group or an amino group, and preferred examples thereof include polyethyleneimine (PEI), polyallylamine hydrochloride (PAH), polydiallyldimethylammonium chloride (PDDA), polyvinylpyridine (PVP), and polylysine. Of these polycations, polyallylamine hydrochloride (PAH) and polydiallyldimethylammonium chloride (PDDA) are particularly preferred.

It is also possible to widely use, in addition to the above polycations and polyanions, polymer compounds having a hydroxyl group or a carboxy group, such as polyacrylic acid, polyvinyl alcohol, and polypyrrole; polysaccharides such as starch, glycogen, alginic acid, carrageenan, and agarose; polyamides such as polyimide, phenol resin, polymethyl methacrylate, and acrylamide; polyvinyl compounds such as vinyl chloride; styrene-based polymers such as polystyrene; and polymers such as polythiophene, polyphenylenevinylene, and polyacetylene, and derivatives and copolymers of these polymers.

As the material of the thin film, an organic low molecule can be widely used, as long as it can coat the surface of the substrate, and preferred examples thereof include surfactant molecules having a long chain alkyl group, long chain thiol group, and halide. It is also possible to use aminotriazine, cyclic imide (cyanuric acid, barbituric acid, thiobarbituric acid, thymine, etc.), guanidinium, and molecules having plural functional groups which have molecular recognizability such as a carboxy group and a phosphoric acid group, which can form a network structure through a hydrogen bond.

It is also possible to use conductive polymers, functional polymer ions such as poly(aniline-N-propanesulfonic acid) (PAN); polysaccharides and biopolymers having charges, such as various deoxyribonucleic acids (DNA), ribonucleic acids (RNA), proteins, oligopeptides, and pectin.

When the thin film is formed of only an organic matter, the organic matter must be selected according to the thin film forming means. For example, when the thin film is formed by an alternate adsorption method, alternate lamination of the polyanion and the polycation is used. Organic polymer ions such as polyanions and polycations are soluble in water, or soluble in a mixed solution of water and/or an organic solvent. As a matter of course, the method is not limited only to the alternate lamination, and it is possible to widely use known thin film forming methods, for example, an LB (Langmuir Blodgett) method, a dip coating method, a spin coating method, a CVD (Chemical Vapor Deposition) method, and chemical or electrical deposition methods.

It is also possible to appropriately use a crosslinking treatment with a crosslinking agent, and a thin-film-strength improving operation through heat, electrical and chemical treatments, so as to increase the mechanical strength of the organic thin film.

The thickness of the thin film in the present invention can be appropriately decided according to the thickness of the nanostructure to be obtained.

Particularly, according to the method of the present invention, it is possible to preferably use as a minute pattern of a semiconductor by adjusting the thickness of the thin film to 100 nm or less, and more preferably from 1 to 50 nm.

Furthermore, by adjusting the size of the mold and the material of the thin film, it is possible to produce those which have self-supporting properties and have a height of 5 to 500 nm and a width of 2 to 100 nm, preferably a height of 10 to 300 nm and a width of 1 to 50 nm, and thus it is preferable.

The thin film used in the present invention can be used either alone, or in combinations of two or more different thin films. In this case, plural kinds of thin films may be formed in the form of a layer on the surface of one mold to for one thin film (for example, a thin film formed by laminating a metal oxide layer and an organic matter layer), or to form a different thin film on each of a plurality of molds.

### <Method for Formation of Thin Film>

The thin film in the present invention can be formed by using conventionally known methods. For example, a surface sol-gel method, an alternate adsorption method, a spin coating method, a dip coating method, an LB method, and a CVD method can be employed.

In the case of the surface sol-gel method, for example according to the method described in Japanese Unexamined Patent Application, First Publication No. 2002-338211, a metal oxide thin film can be formed on the surface of a mold by repeatedly dipping a mold, in which a functional group capable of reacting with a metal alkoxide is exposed on the surface, in a metal alkoxide solution. Regarding the metal oxide thin film, a thin film of a metal oxide is formed from the solution through stepwise adsorption of a metal alkoxide. In the case of the metal oxide thin film formed by this method, the thickness is controlled with nanometer-level accuracy. A metal oxide ultra thin film is formed based on polycondensation of the metal alkoxide, and the mold coating accuracy is adaptive up to a molecular level. Therefore, the shape of a mold structure having a nanometer-level shape is accurately copied.

Examples of the typical compound of the metal oxide include metal alkoxide compounds such as titanium butoxide (Ti(OⁿBu)₄), zirconium propoxide (Zr(OⁿPr)₄), aluminum butoxide (Al(OⁿBu)₄), niobium butoxide (Nb(Oⁿ Bu)₅) (wherein “n” described above examples represents n-(normal), that is, OⁿBu represents CH₃CH₂ CH₂O—, and OⁿPr represents CH₃CH₂ CH₂O—), and tetramethoxysilane (Si(OMe)₄); metal alkoxides having two or more alkoxide groups, such as methyltrimethoxysilane (MeSi(OMe)₃) and diethyldiethoxysilane (Et₂Si(OEt)₂); and metal alkoxides, for example, a double alkoxide compound such as BaTi(OR)ₓ (wherein R represents an alkyl group, and x represents an integer from 2 to 4).

Further examples include isocyanate metal compounds having two or more isocyanate groups (M(NCO)_{x′}) (wherein M represents a metal, and x′ represents an integer from 2 to 4) such as tetraisocyanatesilane (Si(NCO)₄), titanium tetraisocyanate (Ti(NCO)₄), zirconium tetraisocyanate (Zr(NCO)₄), and aluminum triisocyanate (Al(NCO)₃); and halogenated metal compounds having two or more halogens (MX_{n′}, wherein M represents a metal, X represents one kind selected from among F, Cl, Br, and I, and n′ represents an integer from 2 to 4) such as tetrachlorotitanium (TiCl₄) and tetrachlorosilane (SiCl₄).

### <Method for Removing Thin Film>

The method for removing a thin film is not specifically limited so long as it does not depart from the purports of the present invention, and it can be appropriately decided taking into account the kind of thin film and, if necessary, the kin of mold. For example, known methods such as etching, chemical treatment, physical exfoliation, and polishing can be employed.

In the step of removing a portion of the thin film, the portion to be removed is not specifically limited, and any portion may be removed in any manner. It is preferred to remove one plain surface including a portion of the thin film. In this case, the plain surface may be in parallel or perpendicular to a substrate, or may be inclined at a proper angle. As a matter of course, removal may be conducted in another manner.

Particularly, when a rectangular mold is employed, it is preferred to remove only the top face (which may be referred to sometimes as an upper face in the description) of the thin film formed on the surface. Thereby, only the side face of the thin film is left and a nanostructure having self-supporting properties is obtained on a substrate when the mold is removed.

In the case of removing a portion of the thin film, the proportion of the portion to be removed is preferably from 1 to 99%, and more preferably from 5 to 95%, of the entire thin film.

In the case of removing a portion of the thin film, it is preferred to expose a portion of the mold by removing the thin film.

As described above, a portion or all of the mold may be removed in the step of removing a portion of the thin film.

### [Substrate]

Generally, the mold is formed on a substrate. The mold in the present invention includes not only a mold provided so as to contact with the substrate, but also a mold which is provided on top of a mold and/or a thin film provided on the substrate.

The substrate is not specifically limited so long as it does not depart from the purports of the present invention. For example, a smooth substrate may be employed, or a substrate with some protrusion formed thereon may be employed as the substrate. Furthermore, the mold and the substrate may be integrated. In this case, the mold and the substrate can be simultaneously removed.

Therefore, the material and surface properties of the substrate are not specifically limited.

Specifically, preferred examples thereof include solids composed of a metal such as silicone or aluminum, or an inorganic matter such as glass, titanium oxide, or silica; a solid composed of an organic matter such as an acrylic sheet, polystyrene, cellulose, cellulose acetate, or phenolic resin; and a solid in which some nanostructure (or a nano-mold composite partially including a mold) is provided on the surface.

Furthermore, the substrate used in the present invention is used as a foundation when the nanostructure of the present invention is produced, and the thus formed nanostructure can be used by removing from the substrate, or used by transferring to another substrate.

Preferred embodiments of the method for producing a nanostructure of the present invention will now be described with reference to the accompanying drawings. Therefore, it should be understood that other embodiments are not excluded.

### Embodiment (1)

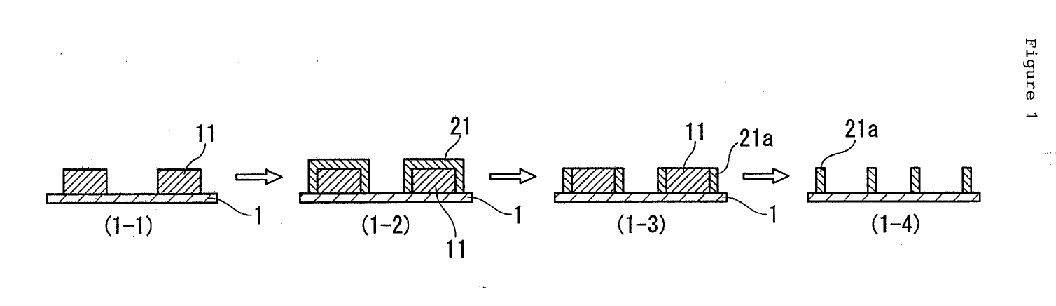

FIG. 1 is a sectional view showing a first embodiment, in which the reference symbol 1 (the portion having a laterally continuous shape) denotes a substrate, the reference symbol 11 denotes a mold formed using the composition for formation of a mold of the present invention, and the reference symbol 21 (the portion around the mold 11) denotes a thin film (the same shall apply hereinafter unless otherwise specified). First, a generally rectangular mold 11 is formed on the substrate 1 (1-1). Then, a thin film 21 is formed so as to coat the surface of the mold 11 (1-2). Furthermore, by removing the upper face at the face which is in parallel to the substrate (particularly preferably removing only the top face of thin film 21 provided on the upper face of the mold 11), a portion of the thin film 21 is removed (1-3). At this time, a portion of the mold 1 may be removed together with the top face of the thin film 21. Then, the mold 11 is removed. Thus, only the thin film 21a of the side face is left to form a nano-level structure (nanostructure) (1-4).

Namely, in the nanostructure of the present invention, accuracy of the resulting nanostructure can be controlled by controlling the thickness of the thin film 21 in the step of forming the thin film 21 on the surface of the mold 11. It becomes possible to produce an extremely minute structure by appropriately deciding the shape of the mold 11. Therefore, it is easy to control the line width, even when a wiring circuit is formed at a minute level. Furthermore, in the nano-level structure of this embodiment, for example, a vertical self-supporting thin structure can also be made. For example, in the case if a nanostructure composed of a metal oxide thin film, the aspect ratio (width/height) is preferably controlled to 1/(300 or less) because self-supporting properties are easily maintained. In the case of an organic/metal oxide composite thin film, the aspect ratio (width/height) is preferably controlled to 1/(100 or less) because self-supporting properties are easily maintained. In order to obtain self-supporting properties more easily, in the case of a metal oxide thin film or organic/metal oxide composite thin film, the aspect ratio (width/height) may be controlled to 1/(10 or less).

It is not always required that a mold structure for coating the thin film 21 is subjected to microfabrication, an the nanostructure of the present invention can be made by appropriately setting the conditions for forming the thin film 21 and the conditions for removing the mold 11, even in the case of a centimeter-order structure. Namely, a two-dimensional pattern having a nanometer-order line width can be formed.

### Embodiment (2)

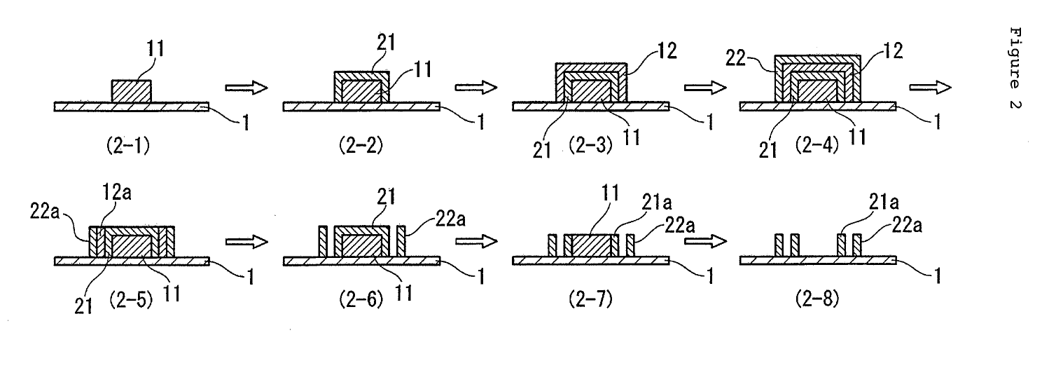

FIG. 2 is a sectional view showing a second embodiment, in which a thin film forming step is conducted several times. First, a first mold 11 was formed on a substrate 1 using the composition for formation of a mold of the present invention (2-1), and then a first thin film 21 is formed on the surface of the first mold 11 (2-2) and also a second mold 12 composed of the composition for formation of a mold of the present invention is forme on the surface of the first thin film 21 (2-3). In this case, the size of the second mold 12 can be appropriately decided according to the shape of the objective nanostructure. In this embodiment, the second mold 12 has nearly the same thickness and shape a those of the first thin film 21, but may have a size and shape which are different from those of the first thin film 21. Then a second thin film 22 is formed on the surface of the second mold 2 (2-4). In this embodiment, the thickness of the second thin film 22 has nearly the same thickness and shape as those of the first thin film 21, but may have a size and shape which are different from those of the first thin film 21. Then, the top face of the second thin film 22 formed later and the top face of the second mold 12 are removed, thereby exposing a portion of the first thin film 21 (2-5). Thereby, a side face portion 22a of the second thin film and a side face portion 12a of the second mold are left. Furthermore, the side face portion 12a of the second mold is removed (2-6). In the same manner as in the first embodiment, the top face of the first thin film 21 is removed to leave the side face portion 21a, and also the first mold 11 is removed to obtain a nanostructure (2-8). In this embodiment, the second thin film 22, the second mold 12, and the first thin film 21 are removed in the stages (2-5) to (2-7) in a phased manner. However, the top face of the first and second thin films 21, 22 may be removed from the stage (2-4) to the stage (2-7) by one process, a d also the first and second molds 11, 12 respectively may be removed at one time. As described above, in this embodiment, the molds 11, 12 and thin films 21, 22 can be alternately provided and, as a result, a more complicated nanostructure can be obtained.

### Embodiment (3)

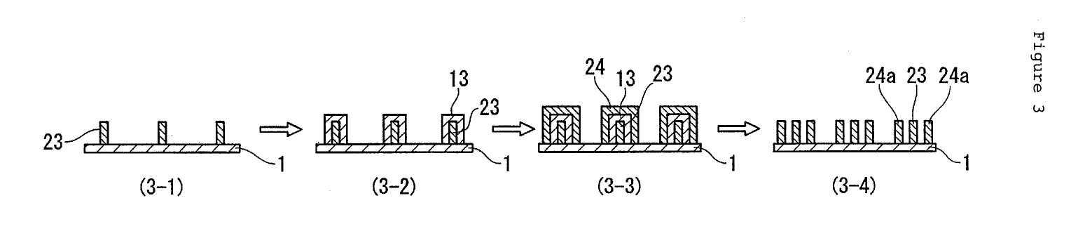

FIG. 3 is a sectional view showing a third embodiment, in which a minute nanostructure is made using a nanostructure 23 obtained by the method of the present invention as the cold. On the surface of the nano-level structure 23 (3-1), a mold 13 composed of the composition for formation of a mold of the present invention is provided (3-2) and also a thin film 24 is formed on the surface (3-3). Then, the top face of the thin film 24 provided in the stage (3-3) and also the mold 13 is removed. Thus, a more complicated structure composed of a nanostructure of the side face portion 24a of the thin film 24 and the nanostructure 23 initially provided is obtained as shown in the stage (3-4). This embodiment is characterized in that the mold 13 is provided on the surface of the nanostructure 23 and the thin film 24 is further formed thereon. With such a construction, it becomes possible to make a more minute structure. It has conventionally been very difficult to make such a minute structure. However, it became possible to form the nanostructure 23 as shown in the stage (3-1), and thus making it possible to easily produce a complicated structure composed of these nanostructures 23, 24a.

### Embodiment (4)

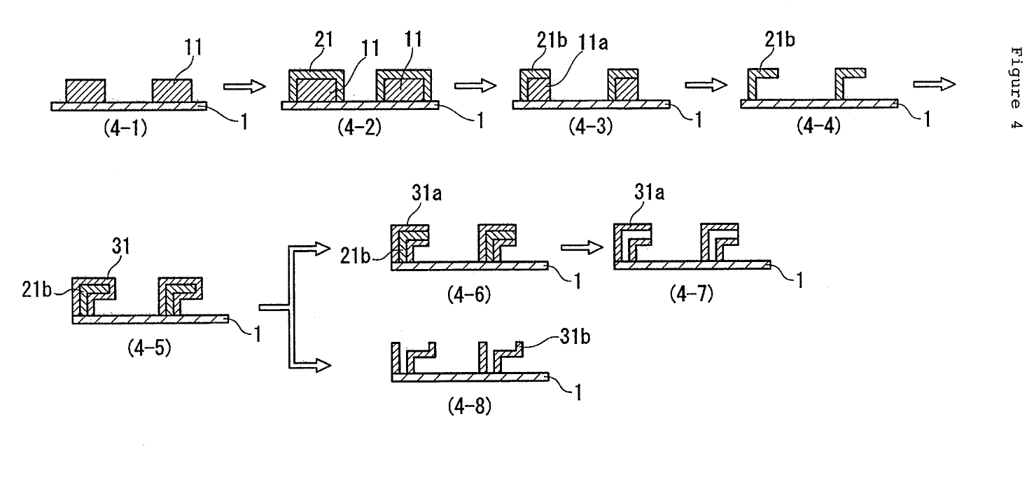

FIG. 4 is a sectional view showing an example of a nanostructure having a more complicated shape. First, a mold 11 composed of the composition for formation of a mold of the resent invention is formed on a substrate 1 (4-1), a thin film 21 is formed on the surface of the mold 11 (4-2), and, furthermore, portion of the structure composed of the mold 11 and the thin film 21 is removed so as to cut at the cross section which is generally perpendicular to the substrate 1 (4-3). In the drawing, the reference symbol 11a denotes a portion of the remaining mold 11, and 21b denotes a portion of the remaining thin film 1. Furthermore, by removing a portion 11a of the remaining mold, a nanostructure having an inverted L-shaped cross section composed of a portion 21b of the remains of thin film as shown in the stage (4-4) is obtained. Using this nanostructure 21b as the mold, a thin film 31 is formed on the surface (4-5). Then, as shown in the stage (4-6), a portion of the thin film 31 (the right portion in the drawing) is removed. In the drawing, the reference symbol 31a denotes the remaining portion of the thin film 31. Furthermore, by removing the mold (nanostructure 21b), as shown in the stage (4-7), a nanostructure composed of the remaining portion 31a of the thin film 31 is obtained.

In contrast, in the stage (4-5), by removing the top face portion of thin film 31 and removing the mold (nanostructure 21b), a nanostructure composed of the remaining portion 31b of the thin film 31 is obtained as shown in the stage (4-8).

This embodiment is characterized in that the nanostructures 31a, 31b are produced by using the nanostructure 21b which is made using the mold 11. With such a configuration, a nano structure having a more complicated structure can be made.

Furthermore, in this embodiment, the thin film 2 and the mold 11 are removed at the face which is generally perpendicular to the mold. As described above, since a portion other than the top face portion of the thin film and/or the mold is removed, a nanostructure having a more complicated structure can be made, and thus it is preferable.

In this embodiment, it is preferred to form the mold 11 and nanostructure 21b (mold), which are finally removed, using the composition for formation of a mold of the present invention. In order to enable etching resistance of the nanostructure 21b to be higher than that of the mold 11, the compositions of both are preferably made different.

### Embodiment (5)

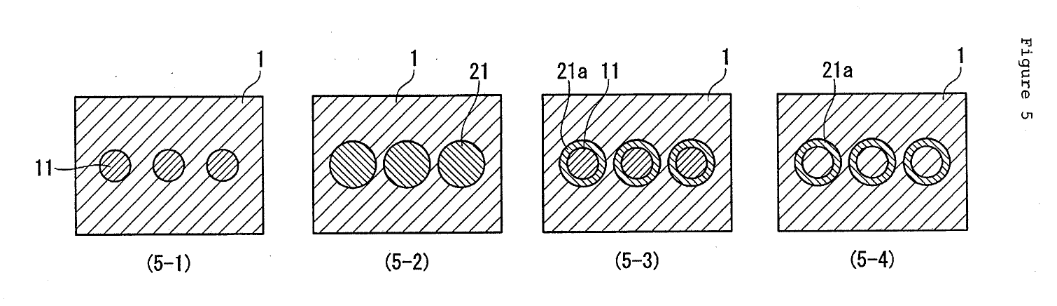

FIG. 5 is a view seen from the upper face side, which shows a fifth embodiment. First, a thin film 21 is formed (5-2 on the surface of a cylindrical mold 11 (5-1) and, furthermore, a portion of the thin film 21 is removed (5-3) and a mold 11 is removed, to obtain a nanostructure composed of the remaining portion 21a of the thin film 21 (5-4). The mold 11 is formed of the composition for formation of a mold of the present invention. In the method for producing a nanostructure of the present invention, the shape of the mold is not specifically limited as long as a thin film can be formed on the surface. Therefore, nanostructures having various shapes can be made.

### Embodiment (6)

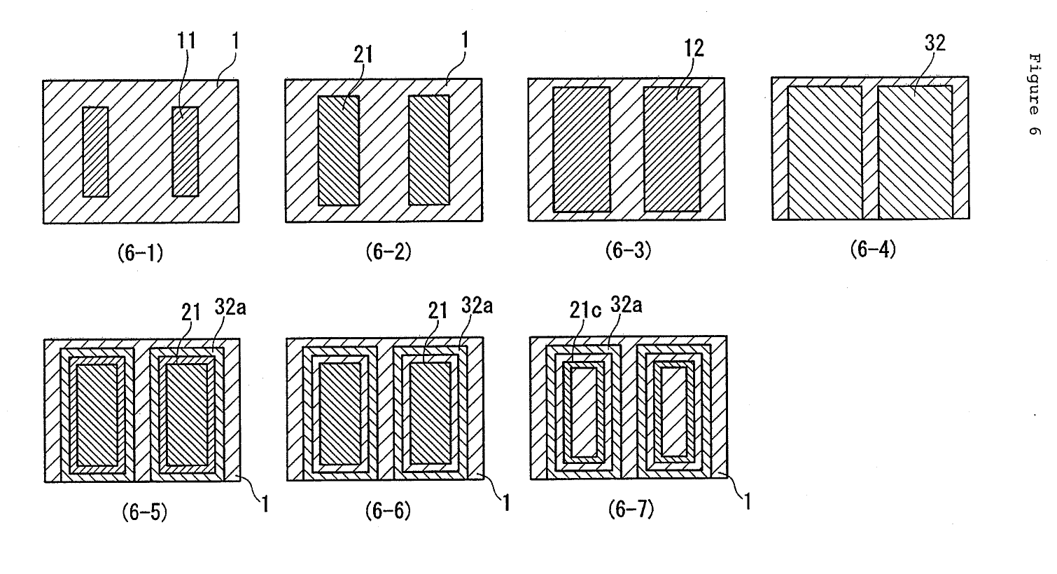

FIG. 6 is a view seen from the upper face side, which shows a six embodiment. First, a first thin film 21 is forme (6-2) on the surface of a first mold 11 (6-1) having a quadratic prism shape, and a second mold 12 is provided on the surface of the first thin film 21 (6-3), and then a second thin film 32 with a composition which is different from that of the first thin film 21 formed in the stage (6-2) is formed on the surface (6-4). The first and second molds 11, 12 are formed of the composition for formation of a mold of the present invention. In the same manner a in the above embodiment, by removing the upper portion of the first thin film 21 and the upper portion of the second thin film 32 as well as the first and second molds 11, 12 (6-5 to 6-7), a nanostructure composed of the remaining portion 21c of the first thin film 21 and the remaining portion 32a of the second thin film 32 is obtained (6-7). In the stage (6-5) shown in FIG. 6, the side face portion of the second mold 12 remains between the first thin film 21 and the remaining portion 32a of the second thin film 32. T e side face portion of the second mold 12 is removed in the stag (6-6) shown in FIG. 6 and, in the stage (6-7) show in FIG. 6, the upper portion of the first thin film 21 and the first mold 11 are removed. In this embodiment, it is possible to easily make a nanostructure in which the composition varies according to the portion, which is very useful. In this embodiment, although the composition of the first mold 11 is the same as that of the second mol 12, the composition of the mold can appropriately vary according to the kind of the film formed on the surface.

### Embodiment (7)

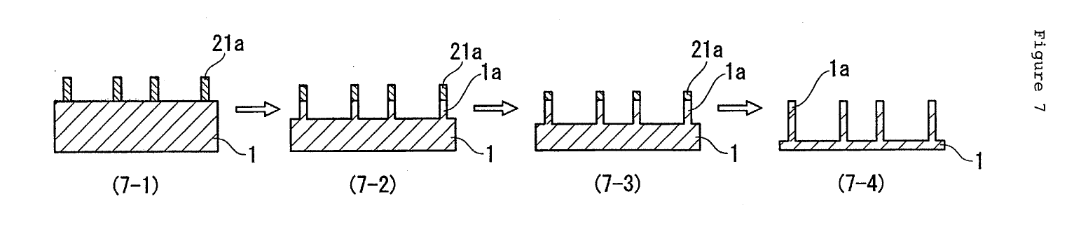

FIG. 7 is a sectional view showing an application example of the nanostructure of the present invention. In this example, in the same manner as in the above first embodiment (1), a nanostructure 21a is formed, and the nanostructure 21 and a portion of the substrate 1 (other than the portion located below the nanostructure 21a) are sequentially removed from the upper portion (7-2, 7-3), using the nanostructure 21a (7-1) as an indicator. In the drawing, the reference symbol 1a denotes the salient left as a result that the portion other than the portion located below the nanostructure 21a is removed out of the upper portion of the substrate 1. Finally, as shown in the stag (7-4), a nano-level structure composed only of the substrate material is obtained (7-4).

As a mater of course, it is also possible to make a nanostructure composed of the substrate material and the thin film material by leaving a portion of the nanostructure 21a derived from the thin film.

### Embodiment (8)

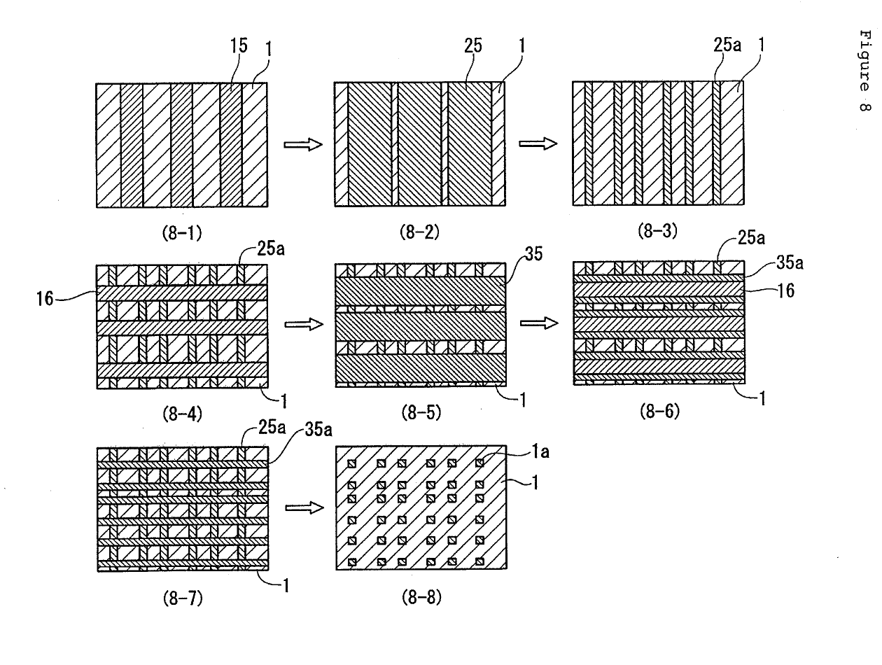

FIG. 8 is a view seen from above, which shows another application example of the nanostructure of the present invention. First, on a substrate 1, a first mold 15 having a quadratic prism shape, in which a planar shape seen from above is quadrangle having one side longer than the other side, is provided (8-1). This first mold 15 is formed of the composition for formation of mold of the present invention. Then, a first thin film 25 is formed on the surface of the first mold 15 (8-2), and, after removing the upper portion of the first thin film 25, the first mold 15 is removed to obtain a first nanostructure composed a portion 25a of the first thin film 25 (8-3). Then, on the surface of a substrate including the surface of a first nanostructure (a portion 25a of the first thin film 25), a long second mold 16 is provided in a direction which is perpendicular to the longitudinal direction of the first mold 15 (8-4). In this stage, the structure does not have a smooth surface, but has irregularity on the surface. Namely, the second mold 16 provided in the stage (8-4) is a recessed mold, relative to the substrate. This second mold 16 is formed of the composition for formation of a mold of the present invention. Then, a second thin film 35 with a composition which is different from that of the first thin film 25 is formed so as to coat the surface of the second mold 16 (8-5), the upper portion of the second thin film 35 is removed (8-6), the second mold 16 is removed, and thus a second nanostructure (a portion 35a of the second thin film 35) is formed (8-7).

Furthermore, if necessary, a nanostructure composed only of a substrate material can be formed by sequentially removing a portion of the first and second nanostructures and the substrate 1 (a portion other than the portion located under first a d second nanostructures) from the upper portion, in the same manner as in the embodiment (7) (8-8). In the drawing, the reference symbol 1a denotes a salient left as a result of removal of a portion of the upper portion of the substrate 1.

This embodiment is characterized in that a nanostructure is further formed on the surface of another nanostructure which has already been provided on the surface of a substrate. According to a conventional method, it was not substantially possible to form a nanostructure with such a complicated construction.

In such a manner, by producing a nanostructure, it is possible to certainly produce a nanostructure obtained by copying or transferring a shape of a mold, with an excellent shape and with good reproducibility. Also, minute control of the mold shape can be conducted, and thus, degree of freedom for shape design of the nanostructure is high.

It becomes possible to produce a minute nanostructure by using the composition for formation of a mold of the present invention, and thus it is also possible to realize a minute nanostructure having a pattern width of about 1 nm.

Also, an expensive exposure apparatus, which was a problem in using a method for formation of a minute pattern in a conventional lithography method, is not required, and degree of freedom for design of materials and processes is high. Furthermore, an improvement in throughput, which was hardly achieved by a conventional method using beam writing, can be realized.

### EXAMPLES

The present invention will now be described in detail by way of examples. Various modifications or variations of the material, the amount, the proportion, the contents of the treatment, and the treatment procedure can be appropriately made, without departing from the purports of the present invention. Therefore, the scope of the present invention is not limited to the following specific examples.

### Example 1

As a composition for formation of a mold which forms a mold, a composition 1 for formation of a mold with the following composition was used.

| | | |
|---|---|---|
| Resin 1 | 100 | parts by mass |
| Resin 2 | 100 | parts by mass |
| Acid generator 1 | 6.5 | parts by mass |
| Additive: Salicylic acid | 0.227 | parts by mass |
| Additive: Triethanolamine | 0.108 | parts by mass |
| Additive: DMAc (dimethyl acetamide) | 5.42 | parts by mass |
| Solvent: PGMEA | 730 | parts by mass |

In the above composition, the resin 1 is a polymer organic compound having a weight average molecular weight of 3,000, comprising a structural unit represented by chemical formula (I-1) shown below and a structural unit represented by chemical formula (III-1) shown below, and m/n in the chemical formulas is 75/25 (unit: mol %). The resin 2 is a polymer organic compound having a weight average molecular weight of 8,000, comprising a structural unit represented by chemical formula (I-1) shown below and a structural unit represented by chemical formula (III-2) shown below, and m/n in the chemical formulas is 75/25 (unit: mol %).

Also, the acid generator 1 is a compound represented by chemical formula (B-1) shown below.

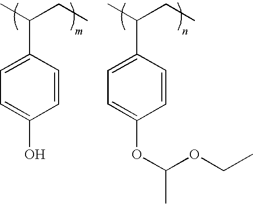

Chemical Formula (I-1) Chemical Formula (III-1)

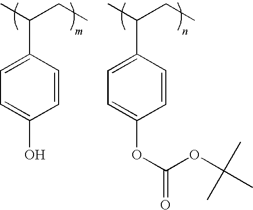

Chemical Formula (I-1) Chemical Formula (III-2)

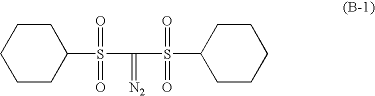

First, the composition for formation of the mold 1 is coated on an 9 inch silicone wafer substrate by a spin coating method and then prebaked under the conditions of a temperature of 90° C. for 90 seconds, to form a film having a thickness of 500 nm.

Using a KrF excimer laser exposure apparatus manufactured by Canon Corp., FPA-3,000EX3 (NA: 0.6, σ: 0.65), the film was exposed.

The film was post-baked (PEB) under the conditions of a temperature of 110° C. for 90 seconds, and then developed with an aqueous 2.38 mass % tetramethylammonium hydroxide solution for 60 seconds, to form a pattern of line and space (LOS), and thus a mold was obtained.

The pattern shape was a rectangular line structure having a width of 340 nm and a height of 400 nm.

The thus obtained structure, in which a rectangular line-shaped mold has been formed on the silicone wafer substrate was subjected to an oxygen plasma treatment (10 W, pressure: 180 mTorr (about 23.9 Pa)), thereby activating the surface of a mold.

Next, the mold was dipped in 10 mL of a silicon tetraisocyanate (Si(NCO)₄) solution (heptane: 100 mM) for 2 minutes, subsequently dipped in 10 mL of hexane for one minute, then dipped in 10 mL of deionized water for one minute, and finally dried with a nitrogen gas flow. A series of this operation (surface sol-gel operation) was conducted fifteen times to form an ultrathin silica film on the surface of the mold. Furthermore, the mold was subjected again to an oxygen plasma treatment (30 W, 2 hours). After exposure, the top face of the ultrathin silica film was removed by argon etching under the conditions of 400 V and a beam current of 80 mA for 2 minutes. Subsequently, this substrate was subjected again to the oxygen plasma treatment (30 W, 2 hours) to remove the mold. Thus, a silica line composed of the side face portion of the ultra-thin silica film was obtained. The resulting silica line was examined by a scanning a electron microscope.

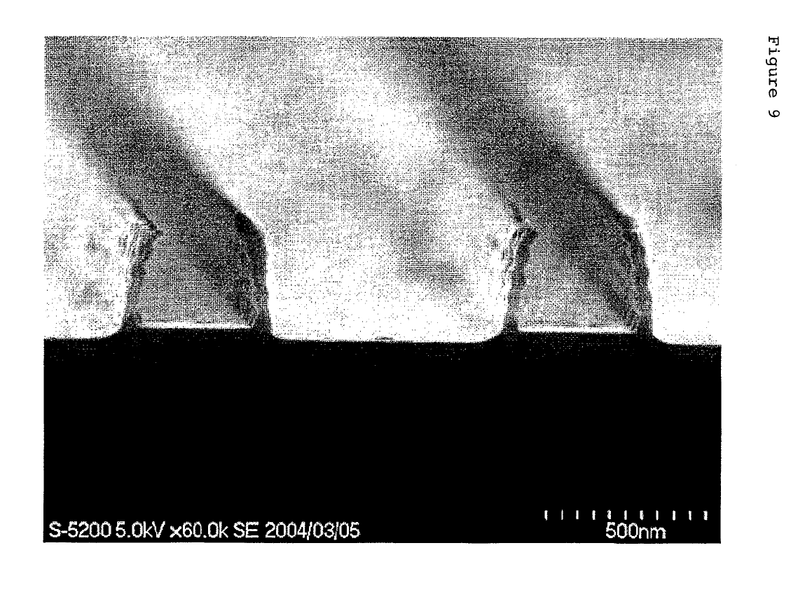

FIG. 9 shows the results, which revealed that a silica line (nanostructure) having a width of about 50 nm and a height of about 400 nm is formed, and also the top face of the line is very smooth. It is found that this silica line has a high aspect ratio (in this case, the ratio height/width is about 8) to a line width, and thus the silica line is self-supportingly retained.

### Example 2

In the same manner as in Example 1, a structure in which a rectangular line-shaped (width: 340 nm, height: 400 nm) mold is formed on a silicone wafer substrate, then subjected to an oxygen plasma treatment in the same manner as in Example 1, and the same sol-gel operation was conducted fifteen times, to form a silica ultra-thin film on the surface of the mold.

The resulting substrate was subjected again to an oxygen plasma treatment (exposed at 30 W for 5 hours and then exposed at 50 W for 4 hours). Subsequently, the substrate was subjected to a baking treatment (450° C., 5 hours), exposed and subjected to argon etching under the conditions of 400 V and a beam current of 80 mA for 2 minutes, thereby removing the top face of the ultra-thin silica film. Subsequently, the mold was removed by being subjected again to the oxygen plasma treatment (30 W, 2 hours). A silica line composed of the side face portion of the ultra-thin silica film was obtained. The resulting silica line was examined by a scanning electron microscope.

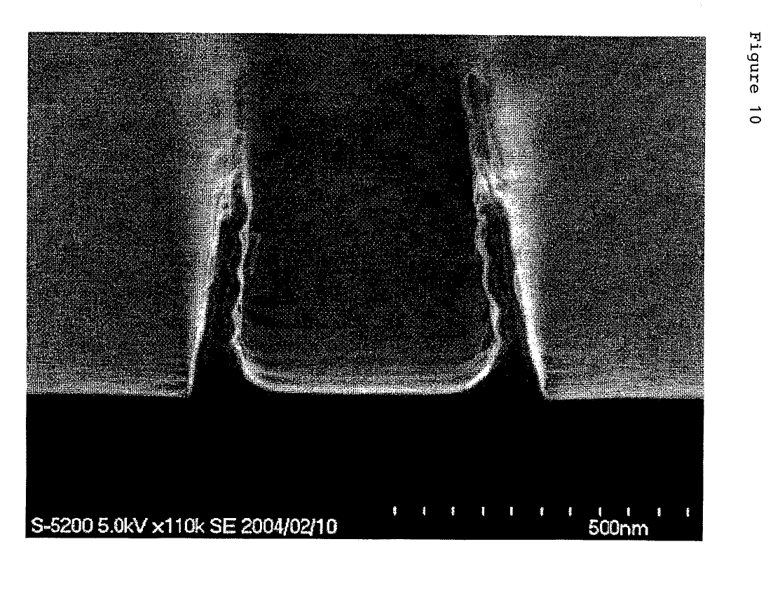

FIG. 10 shows the results, which revealed that a silica line having a width of about 50 nm and a height of about 400 nm is formed, and a silica line is self-sportingly retained similarly to Example 1.

### INDUSTRIAL APPLICABILITY

The method for producing a nanostructure of the present invention can be widely used in the semiconductor field. For example, the method for producing a nanostructure of the present invention can be employed as a method for nanoimprinting. When it is made of a metal oxide, the nanostructure obtained by the method can be used as a thin metal line after the reduction of the metal oxide.

Since the nanostructure of the present invention can provide a material having a nanostructure with controlled accuracy of the shape and size by controlling the thickness of the thin film, it is possible to apply to various fields such as nanostructures, sheets of ultra-thin films, and ultra-fine metal fibers, production of which were considered to be difficult by a microfabrication technology using magnetic waves such as light and an electron beam. Also, when the nanostructure of the present invention is composed of a composite material, wide application for biofunctional materials in which a protein such as an enzyme is incorporated, and for medical materials is expected.

Also, since the nanostructure of the present invent on can be obtained as a self-supporting material by laminating an organic/metal oxide composite thin film having various forms with nanometer accuracy, the nanostructure itself can design new electrical and electronic characteristics, magnetic characteristics, and optical function characteristics. Specifically, it can be used to produce semiconductor photosuperlattice materials, and to design a photochemical reaction with high efficiency and an electrochemical reaction. Also, since the production cost of the nanostructure of the present invention is remarkably lower than that of the other technology, the technology of the present invention can be a practical basic technology such as a light energy conversion system of a solar battery.

Further, it becomes possible to produce various functionally gradient materials from the nanostructure of the present invention by stepwisely varying a lamination ratio of two or more kinds of metal compounds. It also becomes possible to design various organic and inorganic composite ultra-thin films by using various successive adsorption methods of organic matters in combination, which have conventionally been proposed, and thus a nanostructure having new optical, electronic, and chemical functions can be produced.

Furthermore, a nanostructure formed of an amorphous organic/metal oxide composite thin film has lower density than that of a conventional nanostructure containing a metal oxide, and it is expected to be used as a material having an ultra-low dielectric constant and applied in the production of various sensors. It is particularly hopeful as an insulating material of a circuit patterned in a size of 10 to 20 nm and an electronic circuit with irregularity. Furthermore, it is also hopeful as a masking or coating film when the surface of the solid is subjected to ultra-micro processing.

In addition, a nanostructure composed of an amorphous organic/metal oxide composite includes a great number of pores having a molecular size, and therefore can be used to synthesize a new substance, utilizing support of a catalyst and incorporation of ions. Also, different chemical, dynamic, and optical characteristics can be imparted to the surface of the material by incorporating into various materials, and thus application as photocatalyst and the ultrahydrophilic surface can be expected.

According to the present invention, a composition for formation of a mold suited for production of these nanostructures can be obtained.

1. A composition for formation of a mold, which is used in a method for producing a nanostructure by removing a portion of a thin film formed on the surface of a mold and removing the mold,
the composition comprising an organic compound, which has a hydrophilic group and has a molecular weight of 500 or more.

2. A composition for formation of a mold, which is used in a method for producing a nanostructure by removing a portion of a thin film formed on the surface of a mold, thereby exposing a portion of the mold, and removing the mold,
the composition comprising an organic compound, which has a hydrophilic group and has a molecular weight of 500 or more.

3. A composition for formation of a mold, which is used in a method for producing a nanostructure by removing the top face of a thin film formed on the surface of a rectangular mold and removing the mold, thereby leaving only a thin film formed on the side face of the mold,
the composition comprising an organic compound, which has a hydrophilic group and has a molecular weight of 500 or more.

4. A composition for formation of a mold according to claim 1, wherein the thin film is at least one kind selected from the group consisting of a metal oxide, an organic/metal oxide composite, an organic compound, and an organic/inorganic composite.

5. A composition for formation of a mold according to claim 2, wherein the thin film is at least one kind selected from the group consisting of a metal oxide, an organic/metal oxide composite, an organic compound, and an organic/inorganic composite.

6. A composition for formation of a mold according to claim 3, wherein the thin film is at least one kind selected from the group consisting of a metal oxide, an organic/metal oxide composite, an organic compound, and an organic/inorganic composite.

7. A composition for formation of a mold according to claim 4, wherein the thin film is made of silica.

8. A composition for formation of a mold according to claim 5, wherein the thin film is made of silica.

9. A composition for formation of a mold according to claim 6, wherein the thin film is made of silica.

10. A composition for formation of a mold according to claim 1, wherein the hydrophilic group is at least one kind selected from the group consisting of a hydroxyl group, a carboxy group, a carbonyl group, an ester group, an amino group, and an amide group.

11. A composition for formation of a mold according to claim 2, wherein the hydrophilic group is at least one kind selected from the group consisting of a hydroxyl group, a carboxy group, a carbonyl group, an ester group, an amino group, and an amide group.

12. A composition for formation of a mold according to claim 3, wherein the hydrophilic group is at least one kind elected from the group consisting of a hydroxyl group, a carboxy group, a carbonyl group, an ester group, an amino group, and an amide group.

13. A composition for formation of a mold according to claim 10, wherein the hydrophilic group is a phenolic hydroxyl group.

14. A composition for formation of a mold according to claim 11, wherein the hydrophilic group is a phenolic hydroxyl group.

15. A composition for formation of a mold according to claim 12, wherein the hydrophilic group is a phenolic hydroxyl group.

16. A composition for formation of a mold according to claim 1, wherein the method of removing the mold is at least one kind selected from among plasma, ozone oxidization, elution, and firing.

17. A composition for formation of a mold according to claim 2, wherein the method of removing the mold is at least one kind selected from among plasma, ozone oxidization, elution, and firing.

18. A composition for formation of a mold according to claim 3, wherein the method of removing the mold is at least one kind selected from among plasma, ozone oxidization, elution, and firing.

19. A composition for formation of a mold according to claim 1, wherein the organic compound, which is contained in the composition for formation of a mold, is an organic compound which has a molecular weight of more than 2,000 and has 0.2 equivalents or more of a hydrophilic group.

20. A composition for formation of a mold according to claim 2, wherein the organic compound, which is contained in the composition for formation of a mold, is an organic compound which has a molecular weight of more than 2,000 and has 0.2 equivalents or more of a hydrophilic group.

21. A composition for formation of a mold according to claim 3, wherein the organic compound, which is contained in the composition for formation of a mold, is an organic compound which has a molecular weight of more than 2,000 and has 0.2 equivalents or more of a hydrophilic group.

22. A composition for formation of a mold according to claim 1, which is sensitive to radiation.

23. A composition for formation of a mold according to claim 2, which is sensitive to radiation.

24. A composition for formation of a mold according to claim 3, which is sensitive to radiation.

25. A composition for formation of a mold according to claim 1, wherein the organic compound contained in the composition for formation of a mold is a compound having, in addition to a hydrophilic group, an acid dissociable, dissolution inhibiting group, and the composition for formation of a mold further contains an acid generator.

26. A composition for formation of a mold according to claim 2, wherein the organic compound contained in the composition for formation of a mold is a compound having, in addition to a hydrophilic group, an acid dissociable, dissolution inhibiting group, and the composition for formation of a mold further contains an acid generator.

27. A composition for formation of a mold according to claim 3, wherein the organic compound contained in the composition for formation of a mold is a compound having, in addition to a hydrophilic group, an acid dissociable, dissolution inhibiting group, and the composition for formation of a mold further contains an acid generator.

28. A composition for formation of a mold according to claim 25, wherein the organic compound contained in the composition for formation of a mold is a resin having a weight average molecular weight within a range from more than 2,000 to 30,000, comprising a unit having a hydrophilic group and a unit having an acid dissociable, dissolution inhibiting group, and the amount of the unit having a hydrophilic group is 50 mol % or more.

29. A composition for formation of a mold according to claim 26, wherein the organic compound contained in the composition for formation of a mold is a resin having a weight average molecular weight within a range from more than 2,000 to 30,000, comprising a unit having a hydrophilic group and a unit having an acid dissociable, dissolution inhibiting group, and the amount of the unit having a hydrophilic group is 50 mol % or more.

30. A composition for formation of a mold according to claim 27, wherein the organic compound contained in the composition for formation of a mold is a resin having a weight average molecular weight within a range from more than 2,000 to 30,000, comprising a unit having a hydrophilic group and a unit having an acid dissociable, dissolution inhibiting group, and the amount of the unit having a hydrophilic group is 50 mol % or more.

31. A composition for formation of a mold according to claim 28, wherein the unit having a hydrophilic group is a unit derived from hydroxystyrene.

32. A composition for formation of a mold according to claim 29, wherein the unit having a hydrophilic group is a unit derived from hydroxystyrene.

33. A composition for formation of a mold according to claim 30, wherein the unit having a hydrophilic group is a unit derived from hydroxystyrene.
